(19) United States
(12) Patent Application Publication
(10) Pub. No.: US 2020/0111059 A1
(43) Pub. Date: Apr. 9, 2020

(54) METHOD FOR EVENT REMINDING, AND METHOD AND APPARATUS FOR GENERATING EVENT REMINDING MESSAGE

(71) Applicant: Alibaba Group Holding Limited, Grand Cayman, KY (US)

(72) Inventors: Boyu Yang, Hangzhou (CN); Ming Zhang, Hangzhou (CN); Feng BAO, Hangzhou (CN); Jiarui Shi, Hangzhou (CN)

(73) Assignee: Alibaba Group Holding Limited

(21) Appl. No.: 16/705,115

(22) Filed: Dec. 5, 2019

Related U.S. Application Data
(63) Continuation of application No. PCT/CN2018/088652, filed on May 28, 2018.

(30) Foreign Application Priority Data
Jun. 6, 2017 (CN) 201710417733.9

(51) Int. Cl. G06Q 10/10; H04W 4/12; H04W 4/20; H04L 29/08

(52) U.S. Cl. CPC G06Q 10/1095; H04L 67/26; H04W 4/20; H04W 4/12

(57) ABSTRACT

A method including receiving, by a client terminal, an instruction for generating a reminding message for an event type; determining, by the client terminal, a to-be-reminded object and event description information corresponding to the event type; and sending, by the client terminal, a reminding message to the to-be-reminded object, the reminding message containing the event description information. The technical solution of the present disclosure quickly implements event reminding.

### CROSS REFERENCE TO RELATED PATENT APPLICATIONS

This application claims priority to and is a continuation of PCT Patent Application No. PCT/CN2018/088652, filed on 28 May 2018 and entitled “ACTIVITY REMINDER METHOD, AND ACTIVITY REMINDER MESSAGE GENERATION METHOD AND APPARATUS,” which claims priority to Chinese Patent Application No. 201710417733.9 filed on Jun. 6, 2017 and entitled “METHOD FOR EVENT REMINDING, AND METHOD AND APPARATUS FOR GENERATING EVENT REMINDING MESSAGE,” which are incorporated herein by reference in their entirety.

### TECHNICAL FIELD

The present disclosure relates to the field of communication technologies, and, more particularly, to methods for event reminding, and methods and apparatuses for generating an event reminding message.

### BACKGROUND

In conventional techniques, mobile enterprise office platforms are increasingly widely used in office processes of various groups such as enterprises, educational institutions, and government agencies. Such platforms can not only improve the efficiency of communication between users and reduce communication costs, but also effectively enhance the users' event processing efficiency and office efficiency.

For example, a mobile enterprise office platform may be configured to send a reminding message. The reminding message may be sent based on an instant messaging function provided by the mobile enterprise office platform or a traditional mobile communication method such as a short message service (SMS) and a phone call, to ensure the effectiveness of the reminder.

However, the reminder message in the conventional techniques is applied to all scenarios, resulting in failure to effectively highlight some important events that have high requirements for time limits etc. Especially, when many reminding messages are received by a user, or even when reminding messages are abused, these important events are very easily neglected, thereby restricting the reminding effects of the reminding messages.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides methods for event reminding, and methods and apparatuses for generating an event reminding message, to quickly achieve event reminding.

The present disclosure provides the following technical solutions.

According to a first example embodiment of the present disclosure, a method for event reminding is presented, including:
receiving, by a client terminal, an instruction for generating a reminding message for an event type;
determining, by the client terminal, a to-be-reminded object and event description information corresponding to the event type; and
sending, by the client terminal, a reminding message to the to-be-reminded object, the reminding message containing the event description information.

According to a second example embodiment of the present disclosure, a method for event reminding is presented, including:
receiving, by a client terminal, a reminding message of an event type;
displaying, by the client terminal, event description information contained in the reminding message; and
returning, by the client terminal, a corresponding response message to a sender of the reminding message based on a received user's triggering operation for the event description information, the response message including acceptance status information for the event description information indicated by the user's triggering operation.

According to a third example embodiment of the present disclosure, a method for generating an event reminding message is presented, including:
receiving, by a client terminal, an instruction for generating a reminding message;
displaying, by the client terminal, an alternative message type of the reminding message; and
generating, by the client terminal, a corresponding message based on a selected message type.

According to a fourth example embodiment of the present disclosure, an apparatus for event reminding is presented, including:
a receiving unit configured to receive an instruction for generating a reminding message for an event type;
a determining unit configured to determine a to-be-reminded object and event description information corresponding to the event type; and
a sending unit configured to send a reminding message to the to-be-reminded object, the reminding message containing the event description information.

According to a fifth example embodiment of the present disclosure, an apparatus for event reminding is presented, including:
a first receiving unit configured to receive a reminding message of an event type;
a displaying unit configured to display event description information contained in the reminding message; and
a returning unit configured to return a corresponding response message to a sender of the reminding message based on a received user's triggering operation for the event description information, the response message including acceptance status information for the event description information indicated by the user's triggering operation.

According to a sixth example embodiment of the present disclosure, an apparatus for generating an event reminding message is presented, including:
a receiving unit configured to receive an instruction for generating a reminding message;
a displaying unit configured to display an alternative message type of the reminding message; and
an implementing unit configured to generate a corresponding message based on a selected message type.

According to a seventh example embodiment of the present disclosure, a method for event reminding is presented, including:
a client terminal generating a reminding message based on event description information and a to-be-reminded object; and
the client terminal sending a reminding message to the to-be-reminded object, the reminding message containing the event description information.

According to an eighth example embodiment of the present disclosure, an apparatus for event reminding is presented, including:
a generating unit configured to generate a reminding message based on event description information and a to-be-reminded object; and
a sending unit configured to send the reminding message to the to-be-reminded object, the reminding message containing the event description information.

As shown from the above technical solutions, the present disclosure provides a reminding message of an event type to separately send a reminding message for an event with high requirements such as time limits, and effectively distinguish the reminding message of the event type from reminding messages of other types, such that even when a user receives a large number of reminding messages, the user can still quickly distinguish and identify the above events based on the message type and avoid omission.

### BRIEF DESCRIPTION OF THE DRAWINGS

In order to illustrate the technical solutions in the example embodiments of the present disclosure more clearly, the following briefly describes the accompanying drawings which aid in describing the example embodiments. Apparently, the accompanying drawings in the following description merely show some of the example embodiments of the present disclosure, and persons of ordinary skill in the art may derive other drawings from these accompanying drawings without creative efforts.

FIG. 1 presents a schematic architectural diagram of a system for event reminding according to an exemplary embodiment of the present disclosure;

FIG. 2A presents a flowchart of a method for event reminding based on a sender according to an exemplary embodiment of the present disclosure;

FIG. 2B presents a flowchart of another method for event reminding based on a sender according to an exemplary embodiment of the present disclosure;

FIG. 3 presents a flowchart of a method for event reminding based on a receiver according to an exemplary embodiment of the present disclosure;

FIG. 4 presents a flowchart of a method for generating an event reminding message according to an exemplary embodiment of the present disclosure;

FIG. 5 presents a schematic diagram of a reminding message management page of a sender according to an exemplary embodiment of the present disclosure;

FIG. 6 presents a schematic diagram of a message type selection page of a sender according to an exemplary embodiment of the present disclosure;

FIG. 7 presents a schematic diagram of a new conference page of a sender according to an exemplary embodiment of the present disclosure;

FIG. 8 is a schematic diagram of converting a communication message into a reminding message of a sender according to an exemplary embodiment of the present disclosure;

FIG. 9 presents a schematic diagram of a reminding message management page of a receiver according to an exemplary embodiment of the present disclosure;

FIG. 10 presents a schematic diagram of a reminding message detail page of a receiver according to an exemplary embodiment of the present disclosure;

FIG. 11 presents a schematic diagram of another reminding message detail page of a receiver according to an exemplary embodiment of the present disclosure;

FIG. 12 presents a schematic diagram of another reminding message management page of a sender according to an exemplary embodiment of the present disclosure;

FIG. 13A presents a schematic diagram of a response detail page of a sender according to an exemplary embodiment of the present disclosure;

FIG. 13B presents a schematic diagram of another response detail page of a sender according to an exemplary embodiment of the present disclosure;

FIG. 14 presents a schematic diagram of a reason input window of a receiver according to an exemplary embodiment of the present disclosure;

FIG. 15 presents a schematic diagram of still another response detail page of a sender according to an exemplary embodiment of the present disclosure;

FIG. 16 presents a schematic diagram of initiating an adjustment request of a receiver via a reminding message detail page according to an exemplary embodiment of the present disclosure;

FIG. 17 presents another schematic diagram of initiating an adjustment request of a receiver via a reminding message detail page according to an exemplary embodiment of the present disclosure;

FIG. 18 presents still another schematic diagram of initiating an adjustment request of a receiver via a reminding message detail page according to an exemplary embodiment of the present disclosure;

FIG. 19 presents a schematic diagram of processing an adjustment request of a sender via a response detail page according to an exemplary embodiment of the present disclosure;

FIG. 20 presents a schematic diagram of prompting adjusted conference description information of a sender according to an exemplary embodiment of the present disclosure;

FIG. 21 presents a schematic diagram of prompting adjusted conference description information in a new conference reminding message of a receiver according to an exemplary embodiment of the present disclosure;

FIG. 22 presents a schematic diagram of a calendar management page according to an exemplary embodiment of the present disclosure;

FIG. 23 presents a schematic diagram of classifying, filtering, and displaying a reminding message in a reminding message management page according to an exemplary embodiment of the present disclosure;

FIG. 24 presents a schematic diagram of creating a conference reminding message at a PC terminal according to an exemplary embodiment of the present disclosure;

FIG. 25 presents another schematic diagram of creating a conference reminding message at a PC terminal according to an exemplary embodiment of the present disclosure;

FIG. 26 presents still another schematic diagram of creating a conference reminding message at a PC terminal according to an exemplary embodiment of the present disclosure;

FIG. 27 is a schematic structural diagram of an electronic device according to an exemplary embodiment of the present disclosure;

FIG. 28 is a block diagram of an apparatus for event reminding based on a sender according to an exemplary embodiment of the present disclosure;

FIG. 29 is a block diagram of an apparatus for event reminding based on a receiver according to an exemplary embodiment of the present disclosure;

FIG. 30 is a block diagram of another apparatus for event reminding based on a sender according to an exemplary embodiment of the present disclosure;

FIG. 31 is a schematic structural diagram of another electronic device according to an exemplary embodiment of the present disclosure; and

FIG. 32 is a block diagram of an apparatus for generating an event reminding message according to an exemplary embodiment of the present disclosure.

### DETAILED DESCRIPTION

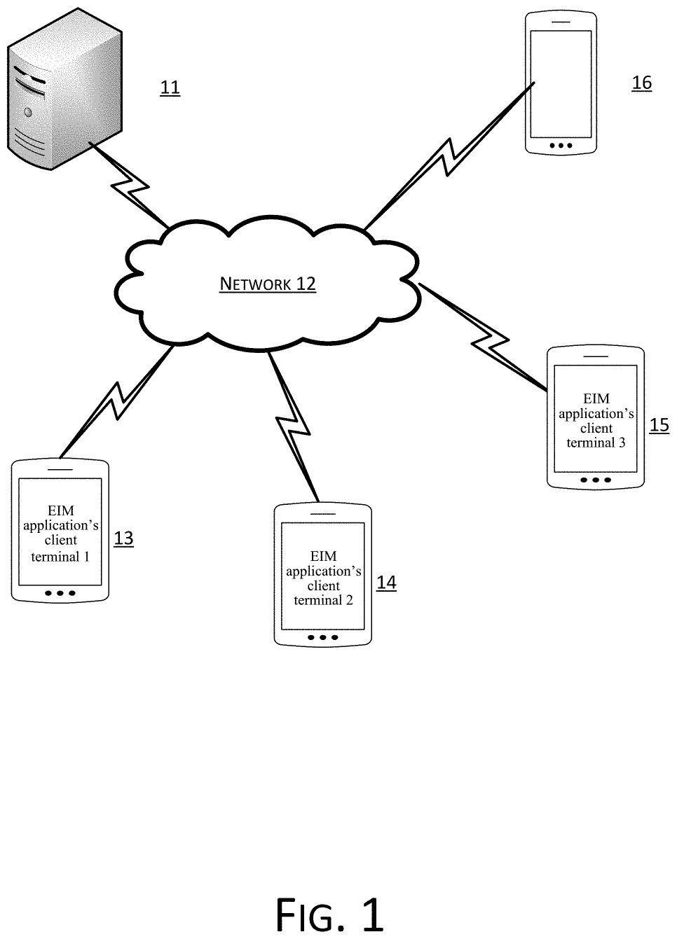

FIG. 1 is a schematic architectural diagram of a system for event reminding according to an exemplary embodiment of the present disclosure. As shown in FIG. 1, the system may include a server 11, a network 12, and one or more electronic devices, such as a mobile phone 13, a mobile phone 14, a mobile phone 15, and a mobile phone 16.

The server 11 may be a physical server including a stand-alone host, or the server 11 may be a virtual server carried by a host cluster, or the server 11 may be a cloud server. During running, the server 11 may run a program of a server terminal of an application, to achieve a related service function of the application. For example, when the server 11 runs a program of a mobile team office platform, the server may be implemented as a server terminal of the mobile team office platform. In the technical solution of the present disclosure, the server 11 may be cooperated with client terminals running on the mobile phones 13-16, to achieve an event reminding scheme.

The mobile enterprise office platform can not only realize a communication function, but also function as an integrated functional platform of many other functions, such as processing of an internal event of an enterprise, such as an approval event (e.g., leave, application for office items, and financial affairs), an attendance event, a task event, and a log event, and processing of an external event of the enterprise, such as meal ordering, and procurement. This is not limited in the present disclosure. More specifically, the mobile enterprise office platform may be carried in instant messaging applications of conventional techniques, e.g., enterprise instant messaging (EIM) applications, such as Skype For Business®, Microsoft Teams®, Yammer®, Workplace®, Slack®, enterprise WeChat®, Facecare®, E-Fetion®, and yixin-im®. Certainly, the instant messaging function is only one of the communication functions supported by the mobile enterprise office platform. The enterprise office platform can further achieve more other functions as mentioned above, the event reminding function to be implemented in the present disclosure, and the like. The description will not be repeated here.

The mobile phones 13-16 are merely one type of electronic device available for users. In practice, the users obviously may further use the following types of electronic devices, such as: tablet devices, notebook computers, Personal Digital Assistants (PDAs), and wearable devices (e.g., smart glasses, and smart watches). This is not to limited in the present disclosure. During running, the electronic device may run a program of a client terminal of an application, to achieve a related service function of the application. For example, when the electronic device runs a program of a mobile team office platform, the electronic device may be implemented as a client terminal of the mobile team office platform. An application program of the client terminal of the mobile enterprise office platform may be pre-installed on the electronic device, such that the client terminal may be started and run on the electronic device. Certainly, when using an online “client terminal” such as HTML5 technology, the client terminal can be obtained and run without the need for installing a corresponding application program on the electronic device.

The network 12, for interaction between the mobile phones 13-16 and the server 11, may include various types of wired or wireless networks. In an embodiment, the network 12 may include a public switched telephone network (PSTN) and the Internet. At the same time, the mobile phones 13-16 and other electronic devices may further communicate and interact with each other via the network 12. For example, a single communication session may be established between any two electronic devices; or, some electronic devices may be involved in a given group communication session, such that any user may send a communication message to all other users in the group communication session through his own electronic device. For example, when the group communication session is an inter-group communication session between a plurality of groups, group members in these groups may perform group communication via the inter-group communication session. For another example, each electronic device may send a reminding message of an event type to one or more other electronic devices via the network 12, to achieve the event reminding function in the present disclosure.

The server 11 may establish a long connection with the mobile phones 13-16 via the network 12, such that the server 11, e.g., sends a push message to the mobile phones 13-16 via the long connection, and the mobile phones 13-16 may also, e.g., send a message to the server 11 based on the long connection. For example, the server 11 may also implement a process of communication with the mobile phones 13-16 based on the network 12 by other approaches. The description will not be repeated here.

Thus, in the implementation process of the technical solution of the present disclosure, a process of interaction between a sender and a receiver of the reminding message of the event type is involved. The technical solution of the present disclosure will be described below respectively from the processing logic and the interaction process of both parties.

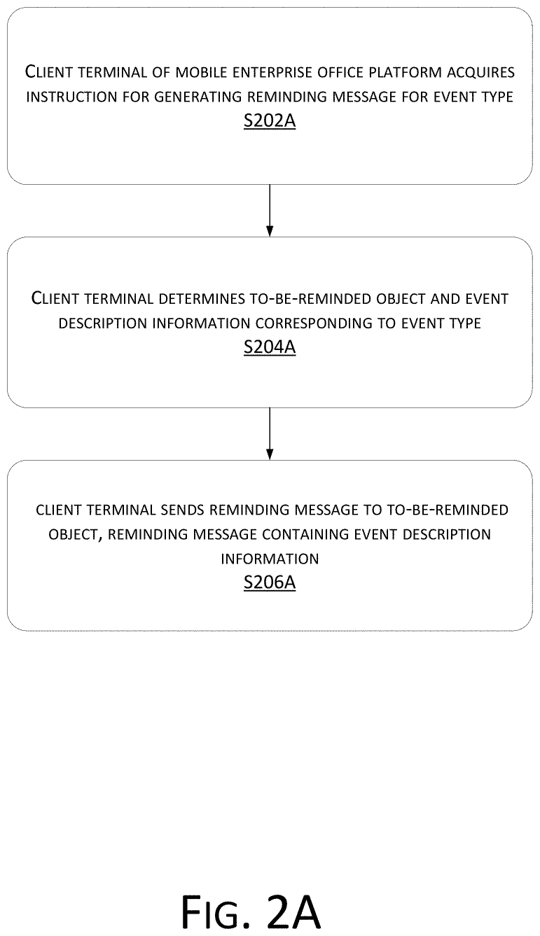

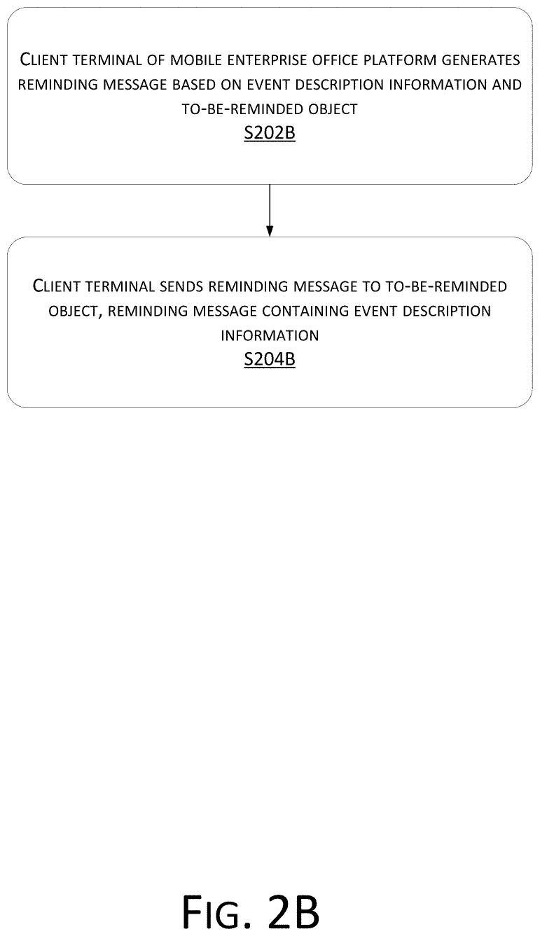

FIG. 2A is a flowchart of a method for event reminding based on a sender according to an exemplary embodiment of the present disclosure. As shown in FIG. 2A, the method is applied to an electronic device used by the sender, and may include the following steps:

Step 202A: a client terminal of a mobile enterprise office platform acquires an instruction for generating a reminding message for an event type.

In the present embodiment, the mobile enterprise office platform may provide various approaches for generating the reminding message, and therefore the instruction for generating a reminding message for the event type may be acquired by many approaches, which are not limited in the present disclosure. In practice, any approach for generating the reminding message applicable to the conventional techniques may be applicable to the present disclosure, to generate the reminding message of the event type.

In an embodiment, the client terminal may receive a user's creating operation for the reminding message and a user's selecting operation for type information of the reminding message, and when the type information selected by the user's selecting operation is an event type, the client terminal determines that the instruction for generating a message is acquired. For example, the client terminal may first provide a user (i.e., the sender in the present embodiment) with a creating option for the reminding message, and when the user triggers the creating option by the user's creating operation, the client terminal may further provide the user with an alternative message type of the reminding message, such that the user selects type information of to-be-created reminding message by the user's selecting operation. For example, the client terminal may directly provide the user with a creating option corresponding to a reminding message of each type respectively, and when the user triggers a creating option corresponding to the reminding message of the event type, both the user's creating operation and the user's selecting operation can be completed, to create the reminding message of the event type.

In another embodiment, the client terminal may receive a user's triggering operation for a communication message within the mobile enterprise office platform. The user's triggering operation is used for instructing the client terminal to convert the communication message into a reminding message. Then, when identifying that message content of the communication message contains event description information of a preset type, the client terminal determines that the instruction for generating a message is acquired. The communication message may include a received message or a sent message within any communication session page of the client terminal. When implementing a preset operation, e.g., click, long press, or heavily press, for the instant message, the user may summon some processing options for the communication message, such as copy, delete, forward, and convert, where the user may select the processing option “convert” to complete the above user's triggering operation, such that the client terminal extracts the message content of the communication message and generates a corresponding reminding message. In the process of generating the reminding message, in the case where the message content contains the event description information of the preset type, the client terminal may generate the reminding message of the event type from the message content of the above communication message based on an identifying result on the message content of the communication message.

The client terminal may acquire the above identifying result by various approaches. In a case, the client terminal may actively identify the message content of the communication message and generate a corresponding identifying result. In another case, the client terminal may initiate an identification request to a server terminal and receive the identifying result for the message content of the communication message returned by the server terminal. In still another case, the client terminal may display and provide alternative message types of a message to the user and determine the corresponding identifying result based on the selecting result of the user. For example, when the user selects the event type, the client terminal may determine that the identifying result is the event description information containing the preset type.

Further, when the message content of the triggered message communication contains the event description information of the preset type, the client terminal may add the event description information to a to-be-generated reminding message of the event type, and may further add a communicator related to the communication message as a to-be-reminded object. For example, assuming that the triggered communication message is “discuss project X in Room 201, Building No. 2 at 2-4 tomorrow afternoon . . . ,” the event description information that may be determined by the client terminal includes: event time information “2-4 tomorrow afternoon” (which may be converted into a specific form of M/D/Y), event location information “Room 201, Building No. 2,” event theme information “discuss project X . . . ” and the like, and the communicator related to the communication message may include a corresponding sender, a corresponding receiver, and the like.

In the present embodiment, the reminding message of the event type is used for implementing a reminding function for an event; where the event may be construed as that a plurality of people participates in and complete a certain action, to achieve a corresponding goal. For example, the event in the present disclosure may include: a conference, a dinner party, a trip, a discussion, and the like, which are not limited in the present disclosure.

Step 204A: the client terminal determines a to-be-reminded object and event description information corresponding to the event type.

In the present embodiment, the event description information may include at least one of the following items: event theme information, event location information, event form information (for example, an offline conference, and an online conference, for another example, a video conference, and a teleconference), event time information (such as an event start moment, and an event end moment; or, e.g., the event start moment and event duration; or, e.g., merely containing the event start moment; or other situations). The event description information may contain one or more event themes, may also contain one or more event locations, and may indicate an event location and event time information corresponding to each event theme, respectively, to more explicitly show event situations.

Step 206A: the client terminal sends a reminding message to the to-be-reminded object, the reminding message containing the event description information.

In the present embodiment, the client terminal sends the reminding message at a default or user-defined sending moment in accordance with a default or user-defined message type. The user may implement regularly sending the reminding message of the event type by defining the sending moment. The sending moment may be any moment that has not taken place yet. For example, the user may directly define an absolute moment, such as “15:25 today,” or may define a relative moment, such as “30 minutes before an event starts,” or a moment in any other form. At the same time, the user may define the message type, to achieve a reminding effect to different extents. For example, the message type may include an “in-app” instant message, a SMS, and a phone call (e.g., voice broadcast message content). The user may select merely one message type, such that the client terminal sends the reminding message merely in a single form, or may select a plurality of message types, such that the client terminal sends the reminding messages in various forms simultaneously.

In the present embodiment, as the receiver, the to-be-reminded object may respond to the reminding message sent by the sender, and then the client terminal may receive a response message returned by the to-be-reminded object. The response message contains acceptance status information for the event description information. Then, the client terminal may display the to-be-reminded object and the corresponding response message associatively, for viewing by the sender. The acceptance status information indicates whether the receiver agrees with the event description information contained in the reminding message of the event type. For example, when the acceptance status information is “agree,” then the receiver may accept the “event theme,” “event location,” “event time,” and the like defined in the event description information, thus having a great probability of participating in the related event; while when the acceptance status information is “reject,” then the receiver may fail to accept at least a part of the event description information, thus having a great probability of failing to participate in the related event.

When the acceptance status information is “reject,” the response message further includes: a reason for rejection. For example, the receiver may explicitly show failure to participate in the related event due to the reasons, such as “too remote event location,” and “too early event time,” such that the sender promptly adjusts the event accordingly, to enhance the probability of the to-be-reminded object participating in the event. The above “reason for rejection” may be an optional item; or a required item when the receiver selects “reject,” to ensure that the sender can adjust the event accordingly, thus enhancing the probability of the to-be-reminded object participating in the event.

In the present embodiment, the client terminal may add a corresponding event in a management calendar of the mobile enterprise office platform based on the event description information, to improve the management efficiency and convenience of the event. The management calendar may contain many types of management events, then for the above events and other management events, different display attributes may be used in the management calendar, such that the sender achieves quickly identifying and distinguishing between the above events and the other management events during viewing.

In the present embodiment, the client terminal may receive an adjustment request presented by the to-be-reminded object for at least one item of the event description information, and the client terminal, when receiving a user's confirming operation for the adjustment request, may send a new reminding message to the to-be-reminded object based on adjusted event description information; or may send an adjustment instruction for the reminding message to the to-be-reminded object based on the adjusted event description information, such that the client terminal used by the to-be-reminded object may adjust the event description information in the previously received reminding message based on the adjustment instruction.

In the present embodiment, when failing to receive a response message returned by the to-be-reminded object within a preset time length after sending the reminding message, the client terminal may automatically resend the reminding message to the to-be-reminded object, to improve the success rate of reminding; or the client terminal may display a repeated reminding option for the to-be-reminded object, such that the user may determine whether repeated reminding is required based on actual situation, and implement a user's triggering operation on the repeated reminding option when determining that the repeated reminding is required, such that the client terminal resends the reminding message to the to-be-reminded object when receiving the user's triggering operation for the repeated reminding option.

In the present embodiment, the reminding message may contain a default or user-defined reminding time point and a default or user-defined reminding action, such that the to-be-reminded object is reminded of an event at the reminding time point based on the reminding action, and reminding content is related to the event description information. The reminding time point may be the event start moment or any moment before the event starts, such as 5 minutes before the event starts, or half an hour before the event starts. The reminding action may include an “in-app” instant message, a SMS, a phone call, and the like. Merely one reminding action may be used, such that the to-be-reminded object obtains event reminding in merely one single form, or various reminding actions may be used, such that the to-be-reminded object simultaneously obtains event reminding in various forms.

In the present embodiment, the client terminal may, based on an event start moment contained in the event description information, further initiate a call request for the to-be-reminded object at the event start moment, to establish an audio connection or video connection. The call request may be used to establish the audio connection or video connection between the client terminal and the to-be-reminded object, or the call request may be used to establish the audio connection or video connection between to-be-reminded objects. In addition, a client terminal or to-be-reminded object that does not yet join in an established audio connection or video connection may further join in the established audio connection or video connection halfway by other approaches. The client terminal automatically initiates the call request, such that not only does the sender not need to manually execute a calling operation via the client terminal, but also starting the event on schedule can be ensured even if the sender forgets operation or does not notice that the event start moment has arrived due to other affairs, thereby avoiding occurrence of delay. In practice, when the sender forgets operation or does not notice that the event start moment has arrived due to other affairs, the client terminal automatically initiates the call request, which may further play a role in reminding the sender, to ensure the smooth progress of the event.

Certainly, in addition to initiating the call request by the client terminal, there may further be other implementation approaches. For example, the client terminal may initiate a call booking request to the server terminal based on the event start moment contained in the event description information. The client terminal may initiate the call booking request at any moment before the event start moment arrives. The call booking request is used for instructing the server terminal to initiate a call to at least one of the client terminals and the to-be-reminded object at the event start moment, to establish an audio connection or video connection. For another example, when the client terminal sends the reminding message to the to-be-reminded object via the server terminal, since the server terminal may acquire the reminding message, and acquire the event description information therein, then the server terminal may initiate, based on an event start moment contained in the event description information, a call to at least one of the client terminal and the to-be-reminded object at the event start moment, to establish an audio connection or video connection, without the need for separately sending the above call booking request or a similar message by the client terminal. For the above scheme of initiating the call by the server terminal, the server terminal may initiate the call only to the client terminal, such that the client terminal establishes a corresponding audio connection or video connection in response to the call, and the to-be-reminded object may join in the audio connection or video connection by other approaches; for example, the server terminal may initiate the call only to the to-be-reminded object, such that the to-be-reminded object establishes a corresponding audio connection or video connection in response to the call, where the server terminal may initiate the call to all to-be-reminded objects simultaneously, or initiate the call only to some to-be-reminded objects, and other to-be-reminded objects may join in the established audio connection or video connection by other approaches. Certainly, the client terminal may also join in the established audio connection or video connection by other approaches; or the server terminal may initiate the call to the client terminal and the to-be-reminded object to establish the audio connection or video connection between the client terminal and the to-be-reminded object.

In the present embodiment, the client terminal may acquire the event form information contained in the event description information. The event form information is used for indicating that the corresponding event is an online event, such as a teleconference, or a video conference, or an offline event, such as a dinner party, or a trip. Then, the client terminal may initiate the call request or the call booking request when determining that the event form information is the online event, such as the teleconference or video conference, to achieve the online event via the corresponding audio connection or video connection between the sender and the to-be-reminded object.

FIG. 2B is a flowchart of another method for event reminding based on a sender according to an exemplary embodiment of the present disclosure. As shown in FIG. 2B, the method is applied to an electronic device used by the sender, and may include the following steps:

Step 202B: a client terminal of a mobile enterprise office platform generates a reminding message based on event description information and a to-be-reminded object.

In the present embodiment, the mobile enterprise office platform may provide various approaches for generating the reminding message, and therefore the instruction for generating a reminding message for the event type may be acquired by many approaches, which are not limited in the present disclosure. In practice, any approach for generating the reminding message applicable to the conventional techniques may be applicable to the present disclosure, to generate the reminding message of the event type.

In an embodiment, the client terminal receives a user's creating operation for the reminding message and a user's selecting operation for type information of the reminding message; and the client terminal generates the reminding message based on the event type, when the type information selected by the user's selecting operation is an event type. For example, the client terminal may first provide the user (i.e., the sender in the present embodiment) with a creating option for the reminding message, and when the user triggers the creating option by the user's creating operation, the client terminal may further provide the user with an alternative message type of the reminding message, such that the user selects type information of to-be-created reminding message selected by the user's selecting operation. For example, the client terminal may directly provide the user with a creating option corresponding to a reminding message of each type respectively, and when the user triggers a creating option corresponding to the reminding message of the event type, both the user's creating operation and the user's selecting operation can be completed, to create the reminding message of the event type.

In another embodiment, the client terminal receives a user's triggering operation for a communication message. The user's triggering operation is used for instructing the client terminal to convert the communication message into a reminding message. Then, the client terminal generates the reminding message when identifying that message content of the communication message contains event description information of a preset type. The communication message may include a received message or sent message within any communication session page of the client terminal. When implementing a preset operation, e.g., click, long press, or heavily press, on the communication message, the user may summon some processing options on the communication message, such as copy, delete, forward, and convert, where the user may select the processing option “convert” to complete the above user's triggering operation, such that the client terminal extracts the message content of the communication message and generates the corresponding reminding message. In the process of generating the reminding message, in the case where the message content contains the event description information of the preset type, the client terminal may generate the reminding message of the event type from the message content of the above communication message based on an identifying result on the message content of the communication message. The above communication message may include a text message, or other message types, such as a voice message, an image message, and a video message, which are not limited in the present disclosure.

The client terminal may acquire the above identifying result by various approaches. In a case, the client terminal may actively identify the message content of the communication message and generate a corresponding identifying result. In another case, the client terminal may initiate an identification request to a server terminal and receive the identifying result for the message content of the communication message returned by the server terminal. In still another case, the client terminal may display and provide alternative message types of a message to the user and determine the corresponding identifying result based on the selecting result of the user. For example, when the user selects the event type, the client terminal may determine that the identifying result is the event description information containing the preset type.

Further, when the message content of the triggered message communication contains the event description information of the preset type, the client terminal may add the event description information to a to-be-generated reminding message of the event type, and may further add a communicator related to the communication message as a to-be-reminded object. For example, assuming that the triggered communication message is “discuss project X in Room 201, Building No. 2 at 2-4 tomorrow afternoon . . . ,” the event description information that may be determined by the client terminal includes: event time information “2-4 tomorrow afternoon” (which may be converted into a specific form of M/D/Y), event location information “Room 201, Building No. 2,” event theme information “discuss project X . . . ” and the like, and the communicator related to the communication message may include a corresponding sender, a corresponding receiver, and the like.

In the present embodiment, the reminding message of the event type is used for implementing a reminding function for an event; where the event may be construed as that a plurality of people participates in and complete a certain action, to achieve a corresponding goal. For example, the event in the present disclosure may include: a conference, a dinner party, a trip, a discussion, and the like, which are not limited in the present disclosure.

In the present embodiment, the event description information may include at least one of the following items: event theme information, event location information, event form information (for example, an offline conference, and an online conference, for another example, a video conference, and a teleconference), event time information (such as an event start moment, and an event end moment; or, e.g., the event start moment and event duration; or, e.g., merely containing the event start moment; or other situations). The event description information may contain one or more event themes, may also contain one or more event locations, and may indicate an event location and event time information corresponding to each event theme, respectively, to more explicitly show event situations.

Step 204B: the client terminal sends a reminding message to the to-be-reminded object, the reminding message containing the event description information.

In the present embodiment, the client terminal sends the reminding message at a default or user-defined sending moment in accordance with a default or user-defined message type. The user may implement regularly sending the reminding message of the event type by defining the sending moment. The sending moment may be any moment that has not taken place yet. For example, the user may directly define an absolute moment, such as “15:25 today,” or may define a relative moment, such as “30 minutes before an event starts,” or a moment in any other form. At the same time, the user may define the message type, to achieve a reminding effect to different extents. For example, the message type may include an “in-app” instant message, a SMS, and a phone call (e.g., voice broadcast message content). The user may select merely one message type, such that the client terminal sends the reminding message merely in a single form, or may select a plurality of message types, such that the client terminal sends the reminding messages in various forms simultaneously.

In the present embodiment, as the receiver, the to-be-reminded object may respond to the reminding message sent by the sender, and then the client terminal may receive a response message returned by the to-be-reminded object. The response message contains acceptance status information for the event description information. Then, the client terminal may display the to-be-reminded object and the corresponding response message associatively, for viewing by the sender. The acceptance status information indicates whether the receiver agrees with the event description information contained in the reminding message of the event type. For example, when the acceptance status information is “agree,” then the receiver may accept the “event theme,” “event location,” “event time,” and the like defined in the event description information, thus having a great probability of participating in the related event; while when the acceptance status information is “reject,” then the receiver may fail to accept at least a part of the event description information, thus having a great probability of failing to participate in the related event.

When the acceptance status information is “reject,” the response message further includes: a reason for rejection. For example, the receiver may explicitly show failure to participate in the related event due to the reasons, such as “too remote event location,” and “too early event time,” such that the sender promptly adjusts the event accordingly, to enhance the probability of the to-be-reminded object participating in the event. The above “reason for rejection” may be an optional item; or a required item when the receiver selects “reject,” to ensure that the sender can adjust the event accordingly, thus enhancing the probability of the to-be-reminded object participating in the event.

In the present embodiment, the client terminal may add a corresponding event in the management calendar of the mobile enterprise office platform based on the event description information, to improve the management efficiency and convenience of the event. The management calendar may contain many types of management events, then for the above events and other management events, different display attributes may be used in the management calendar, such that the sender achieves quickly identifying and distinguishing between the above events and the other management events during viewing.

In the present embodiment, the client terminal may receive an adjustment request presented by the to-be-reminded object for at least one item of the event description information, and the client terminal, when receiving a user's confirming operation for the adjustment request, may send a new reminding message to the to-be-reminded object based on adjusted event description information; or may send an adjustment instruction for the reminding message to the to-be-reminded object based on the adjusted event description information, such that the client terminal used by the to-be-reminded object may adjust the event description information in the previously received reminding message based on the adjustment instruction.

In the present embodiment, when failing to receive a response message returned by the to-be-reminded object within a preset time length after sending the reminding message, the client terminal may automatically resend the reminding message to the to-be-reminded object, to improve the success rate of reminding; or the client terminal may display a repeated reminding option for the to-be-reminded object, such that the user may determine whether repeated reminding is required based on actual situation, and implement a user's triggering operation on the repeated reminding option when determining that the repeated reminding is required, such that the client terminal resends the reminding message to the to-be-reminded object when receiving the user's triggering operation for the repeated reminding option.

In the present embodiment, the reminding message may contain a default or user-defined reminding time point and a default or user-defined reminding action, such that the to-be-reminded object is reminded of an event at the reminding time point based on the reminding action, and reminding content is related to the event description information. The reminding time point may be the event start moment or any moment before the event starts, such as 5 minutes before the event starts, or half an hour before the event starts. The reminding action may include an “in-app” instant message, a SMS, a phone call, and the like. Merely one reminding action may be used, such that the to-be-reminded object obtains event reminding in merely one single form, or various reminding actions may be used, such that the to-be-reminded object simultaneously obtains event reminding in various forms.

In the present embodiment, the client terminal may, based on an event start moment contained in the event description information, further initiate a call request for the to-be-reminded object at the event start moment, to establish an audio connection or video connection. The call request may be used to establish the audio connection or video connection between the client terminal and the to-be-reminded object, or the call request may be used to establish the audio connection or video connection between to-be-reminded objects. In addition, a client terminal or to-be-reminded object that does not yet join in an established audio connection or video connection may further join in the established audio connection or video connection halfway by other approaches. The client terminal automatically initiates the call request, such that not only does the sender not need to manually execute a calling operation via the client terminal, but also starting the event on schedule can be ensured even if the sender forgets operation or does not notice that the event start moment has arrived due to other affairs, thereby avoiding occurrence of delay. In practice, when the sender forgets operation or does not notice that the event start moment has arrived due to other affairs, the client terminal automatically initiates the call request, which may further play a role in reminding the sender, to ensure the smooth progress of the event.

Certainly, in addition to initiating the call request by the client terminal, there may further be other implementation approaches. For example, the client terminal may initiate a call booking request to the server terminal based on the event start moment contained in the event description information. The client terminal may initiate the call booking request at any moment before the event start moment arrives. The call booking request is used for instructing the server terminal to initiate a call to at least one of the client terminals and the to-be-reminded object at the event start moment, to establish an audio connection or video connection. For another example, when the client terminal sends the reminding message to the to-be-reminded object via the server terminal, since the server terminal may acquire the reminding message, and acquire the event description information therein, then the server terminal may initiate, based on an event start moment contained in the event description information, a call to at least one of the client terminal and the to-be-reminded object at the event start moment, to establish an audio connection or video connection, without the need for separately sending the above call booking request or a similar message by the client terminal. For the above scheme of initiating the call by the server terminal, the server terminal may initiate the call only to the client terminal, such that the client terminal establishes a corresponding audio connection or video connection in response to the call, and the to-be-reminded object may join in the audio connection or video connection by other approaches; for example, the server terminal may initiate the call only to the to-be-reminded object, such that the to-be-reminded object establishes a corresponding audio connection or video connection in response to the call, where the server terminal may initiate the call to all to-be-reminded objects simultaneously, or initiate the call only to some to-be-reminded objects, and other to-be-reminded objects may join in the established audio connection or video connection by other approaches. Certainly, the client terminal may also join in the established audio connection or video connection by other approaches; or the server terminal may initiate the call to the client terminal and the to-be-reminded object to establish the audio connection or video connection between the client terminal and the to-be-reminded object.

In the present embodiment, the client terminal may acquire the event form information contained in the event description information. The event form information is used for indicating that the corresponding event is an online event, such as a teleconference, or a video conference, or an offline event, such as a dinner party, or a trip. Then, the client terminal may initiate the call request or the call booking request when determining that the event form information is the online event, such as the teleconference or video conference, to achieve the online event via the corresponding audio connection or video connection between the sender and the to-be-reminded object.

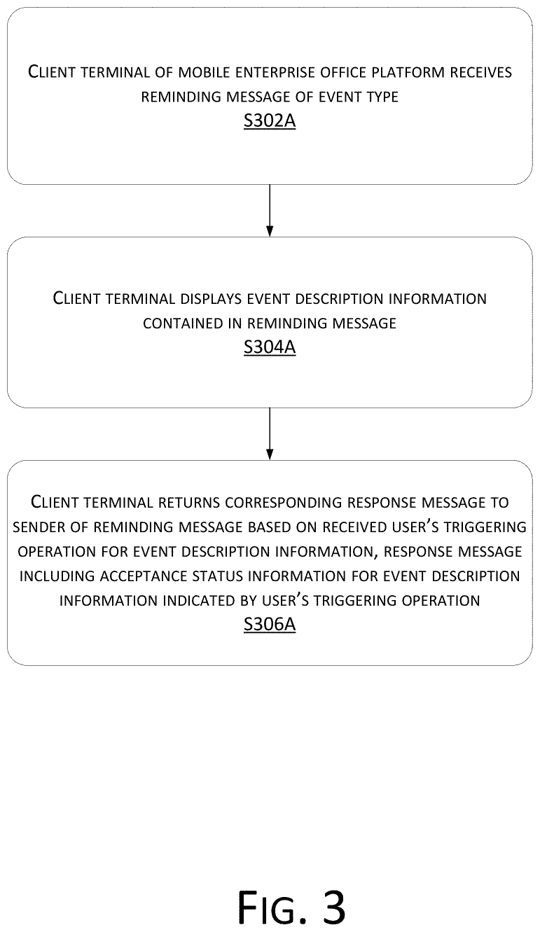

FIG. 3 is a flowchart of a method for event reminding based on a receiver according to an exemplary embodiment of the present disclosure. As shown in FIG. 3, the method is applied to an electronic device used by the receiver, and may include the following steps:

Step 302: a client terminal of a mobile enterprise office platform receives a reminding message of an event type.

Step 304: the client terminal displaying event description information contained in the reminding message.

Step 306: the client terminal returns a corresponding response message to a sender of the reminding message based on a received user's triggering operation for the event description information, the response message including acceptance status information for the event description information indicated by the user's triggering operation.

In an embodiment, based on a user's triggering operation of a receiver, the client terminal may directly return a corresponding response message to inform the sender of corresponding acceptance status information.

In another embodiment, the client terminal may use different processing approaches on the user's triggering operation based on the acceptance status information of the receiver. For example, when the acceptance status information indicated by the user's triggering operation is “agree,” the client terminal may directly return the response message; while when the acceptance status information indicated by the user's triggering operation is “reject,” the client terminal may further acquire a corresponding reason for rejection, add the reason for rejection to the response message, and return the resulting response message to the sender. The client terminal may display preset alternative reasons for rejection to the receiver, for selection by the receiver. For example, the client terminal may provide a reason input box to the receiver, such that the receiver fills a corresponding reason for rejection in the reason input box. Filling the reason for rejection may not be an imperative operation, i.e., the receiver may decide whether to input the reason for rejection at discretion, which will not affect sending the response message; or filling the reason for rejection may be an imperative operation, and only after inputting the reason for rejection, can the receiver send the response message, to ensure that the sender can understand the receiver's acceptance status of the event description information, and reasonably adjust the event based on the reason for rejection.

In the present embodiment, when the acceptance status information indicated by the user's triggering operation is “agree,” the client terminal may add a corresponding event in a management calendar of the mobile enterprise office platform based on the event description information. Processing of the management calendar and the event is similar to the processing of the sender. Reference may be made to the description in the embodiment shown in FIG. 2A or FIG. 2B, which will not be repeated here.

In the present embodiment, when the acceptance status information indicated by the user's triggering operation is “reject,” the client terminal may further acquire adjustment information for at least one item of the event description information and send an adjustment request containing the adjustment information to the sender. Accordingly, if the sender confirms to accept the adjustment request, the client terminal of the sender may adjust the event description information, and further inform each to-be-reminded object of adjusted event description information. For example, the client terminal of the sender may send a new reminding message to the to-be-reminded object based on the adjusted event description information, or may send an adjustment instruction for the reminding message to the to-be-reminded object based on the adjusted event description information, and the client terminal of the receiver adjusts the event description information in the reminding message based on the adjustment instruction.

In the present embodiment, the client terminal may acquire a reminding time point and a reminding action contained in the reminding message, and initiate an event reminding request corresponding to the reminding time point and the reminding action to a server terminal of an instant messaging application; and then the server terminal may remind the receiver of the event in response to an event reminding event initiated by the server terminal at the reminding time point in the reminding action, especially when there is a long internal between the moment of receiving the reminding message of the event type and an event start moment, so as to prevent the receiver from missing the event due to forgetting or being late.

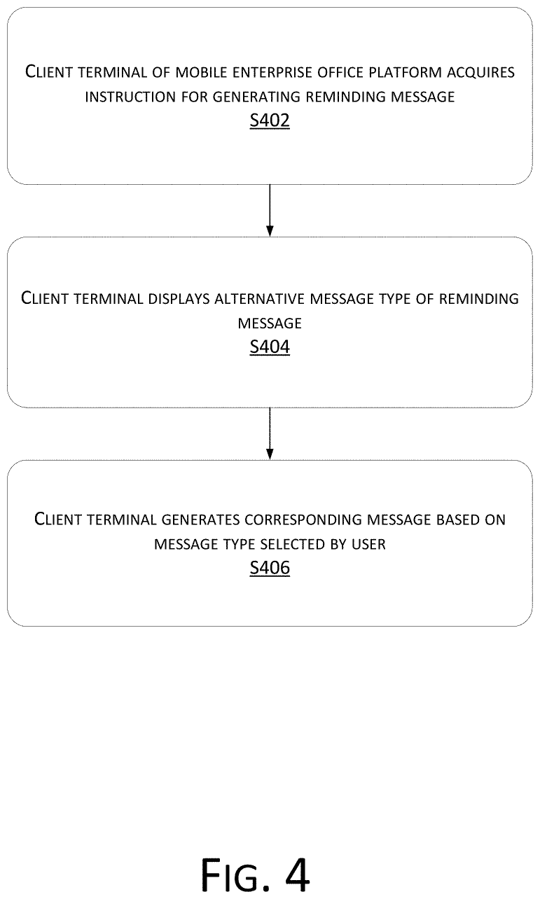

In addition, for features of reminding messages of various types provided by a mobile enterprise office platform of the present disclosure, FIG. 4 presents a flowchart of a method for event reminding based on a sender according to an exemplary embodiment of the present disclosure. As shown in FIG. 4, the method is applied to an electronic device used by the sender, and may include the following steps:

Step 402: a client terminal of a mobile enterprise office platform acquires an instruction for generating a reminding message.

Step 404: the client terminal displays an alternative message type of the reminding message.

In the present embodiment, the alternate message type may include at least one of the following items: a standard type, a task type, an event type, an urging type, and a voting type, which are not limited in the present disclosure.

Step 406: the client terminal generates a corresponding message based on a message type selected by a user.

As shown from the above technical solutions, the present disclosure provides a reminding message of an event type, to separately send a reminding message for an event with high requirements for, e.g., time limits, and effectively distinguish the reminding message of the event type from reminding messages of other types, such that even when a user receives a large number of reminding messages, the user can still quickly distinguish and identify the above events based on the message type and avoid omission.

For the ease of understanding, the technical solutions of the present disclosure will be described below by taking an EIM application as an example. Assuming that an EIM application's client terminal runs on the mobile phone 13, the mobile phone 14, and the mobile phone 15, and an EIM application's server terminal runs on the server 11, registered accounts of different users log on the EIM application's client terminal on the mobile phones 13-15 respectively, for example, a registered account A (i.e., a user A) of the sender logs on the mobile phone 13, such that the mobile phone 13 is configured to be a sender's device corresponding to the sender. An EIM application's client terminal 1 corresponding to the sender logs on the mobile phone 13, a registered account B (i.e., a user B) of a receiver logs on the mobile phone 14, and a registered account C (i.e., a user C) of a receiver logs on the mobile phone 15, such that the mobile phones 14-15 are configured to be receiver's devices corresponding to the two receivers, and an EIM application's client terminal 2 and an EIM application's client terminal 3 corresponding to the two receivers log on the mobile phones 14-15. The user A may fast create a conference reminding message on the mobile phone 13, and send the conference reminding message to the user B and the user C, to achieve conference reminding of the user B and the user C. The technical solutions of the present disclosure will be described in detail below based on the process.

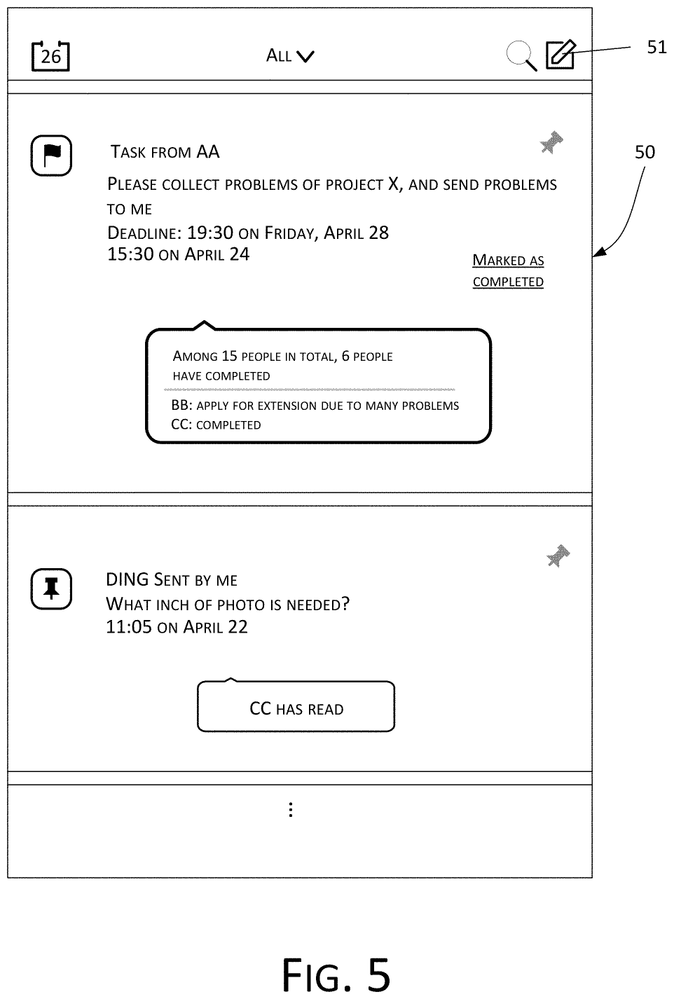

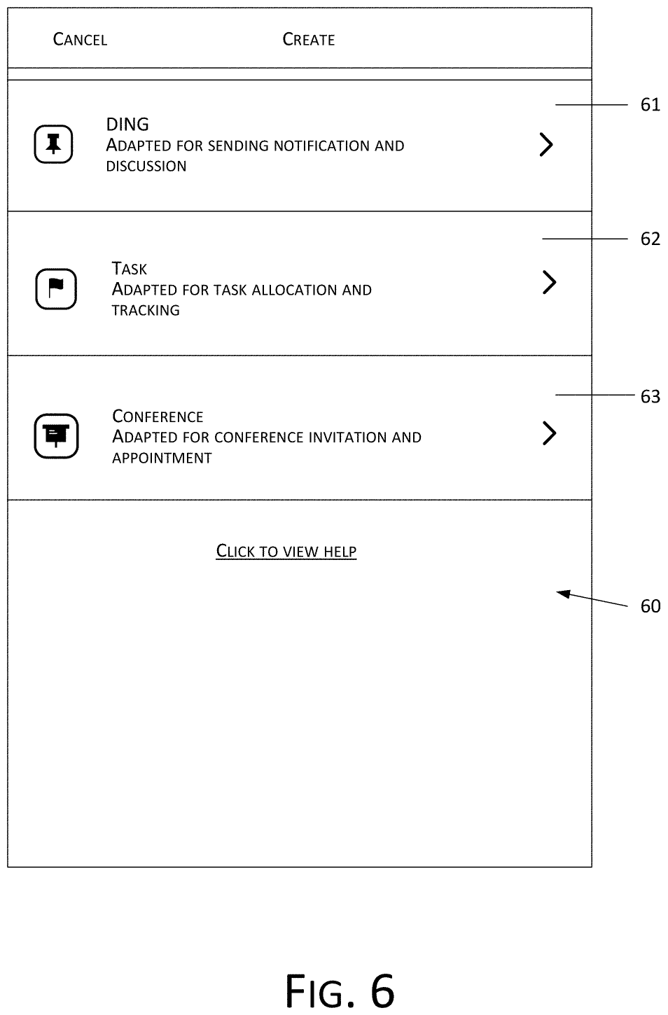

FIG. 5 shows a reminding message management page 50 contained in the EIM application's client terminal 1 on the mobile phone 13. The reminding message management page 50 is used for concentrated display of all reminding messages received and sent by the user A, such as a reminding message of a task type from a user AA, and a reminding message of a DING type (i.e., a reminding message of a standard type) sent by the user A himself. Moreover, the reminding message management page 50 may also be used for implementing other functions related to the reminding message. For example, when detecting that the user A triggers an identifier “create” 51 on the top right corner of the reminding message management page 50, the EIM application's client terminal 1 on the mobile phone 13 receives a user's creating operation for the reminding message of the user A, thus switching to a message type selection page 60 shown in FIG. 6, such that the user A further selects a message type of a to-be-created reminding message.

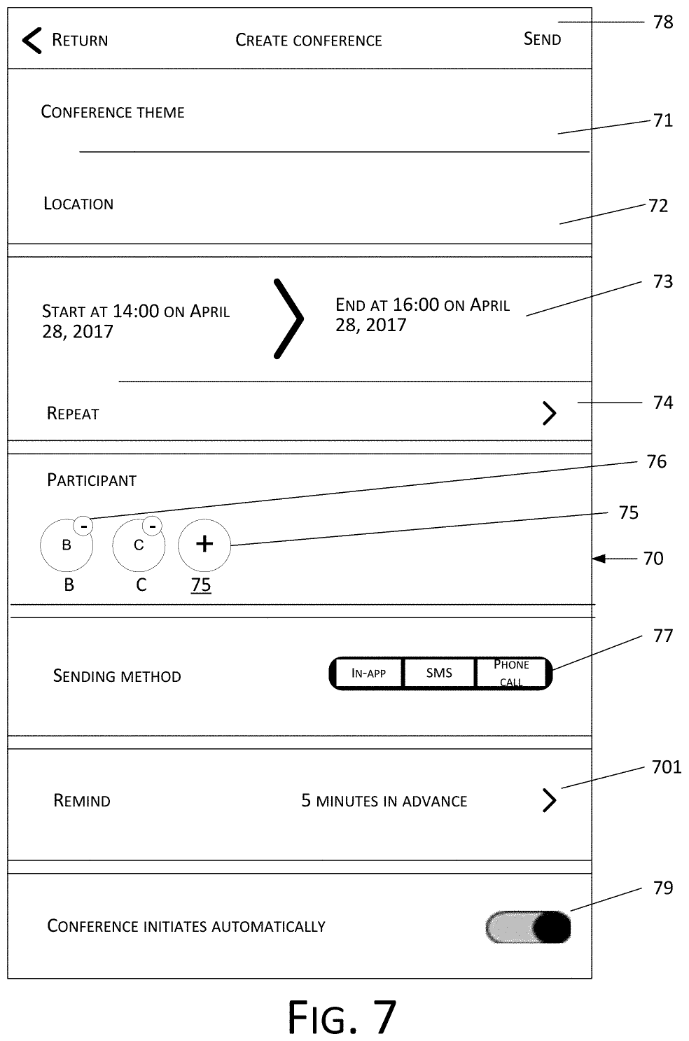

As shown in FIG. 6, the message type selection page 60 may include a plurality of alternative message types, for example, the DING type adapted for sending a notification and discussion, the task type adapted for task allocation and tracking, and a conference type adapted for conference invitation and appointment. Certainly, the message types are not limited in the present disclosure. The EIM application's client terminal 1 may determine the message type of the to-be-created reminding message based on a received user's selecting operation of the user A for an option 61, an option 62, or an option 63. For example, assuming that a user's selecting operation for the option 63 is received, the EIM application's client terminal 1 may determine that the user A would like to create a reminding message of a conference type, thereby displaying a new conference page 70 shown in FIG. 7, such that the user A fills related information in the a new conference page 70 for creating a corresponding conference reminding message.

As shown in FIG. 7, the user A may input “conference theme” information in conference description information into an input box 71, i.e., to-be-negotiated major content of a conference, such as “discuss existing problems and further development needs of project X.” The user A may input “location” information in the conference description information into the input box 72, i.e., a conference venue, such as “Room 201, Building No. 2.” The user A may edit conference time information in the conference description information within a time edit box 73, such as a conference start moment “14:00 on Apr. 28, 2017,” and a conference end moment “16:00 on Apr. 28, 2017.” Certainly, the conference time information may also take other forms, such as “conference start moment+conference duration.” This is not limited in the present disclosure. The user A may define whether to automatically repeatedly send a currently created conference reminding message via an option 74. For example, when the user A defines that it is not necessary to repeatedly send the conference reminding message, the conference reminding message will be sent once only after the user A triggers a “send” option 78; while when the user A defines that it is necessary to repeatedly send the conference reminding message, the EIM application's client terminal 1 may repeatedly send the conference reminding message based on a repetition period further defined by the user A, until reaching the conference start moment or conference end moment, thereby automatically achieving repeatedly reminding the user B and the user C. The user A may select desired users to be added as to-be-reminded objects (i.e., participants) via an “add” option 75. The to-be-reminded object may come from an associated user of the user A, such as in-app contacts (e.g., friends) on the EIM application's client terminal 1, phone contacts within the mobile phone 13, team members (e.g., colleagues within an enterprise) of a team (e.g., an enterprise) of the user A recorded on the EIM application's client terminal 1, and corresponding external contacts (e.g., team members of an external team associated with the team of the user A) of the user A recorded on the EIM application's client terminal 1, which are not limited in the present disclosure. The user A may further delete a corresponding to-be-reminded object via a “delete” option 76 corresponding to each added to-be-reminded object (e.g., the user B and the C shown in FIG. 7). The user A may select a desired sending approach for the conference reminding message via a “sending approach” option 77. For example, the sending approach may include “in-app” based on an instant messaging technology, a “SMS,” a “phone call,” and the like, and the user A may select one or more sending approaches simultaneously. The user A may define whether it is necessary to start a reminding function for the currently created conference reminding message via a “remind” option 701, and further define a reminding time point of the reminding function when the user A defines that it is necessary to start the reminding function. For example, when the reminding time point is “5 minutes in advance” shown in FIG. 7, the to-be-reminded object may be reminded 5 minutes before the conference start moment to avoid omission. At the same time, the user A may further define a reminding action, which is selected like the above “sending approach,” and may include, for example, one or more reminding actions, such as “in-app,” “SMS,” and “phone call.”

The user A may determine whether the EIM application's client terminal 1 actively initiates a calling operation to the to-be-reminded objects by triggering an “Conference initiates automatically” option 79; where when the “Conference initiates automatically” option 79 is enabled, the EIM application's client terminal 1 may automatically initiate a call request of a teleconference or video conference to the to-be-reminded objects at the conference start moment, to achieve the teleconference or video conference between the user A and the to-be-reminded objects, or achieve the teleconference or video conference between the to-be-reminded objects (i.e., the user A may not participate in the conference) . Certainly, the user A and the to-be-reminded objects may also join in an established teleconference or video conference halfway. For example, when the “Conference initiates automatically” option 79 is enabled, the EIM application's client terminal 1 may initiate a call booking request to an EIM application's server terminal 1 before the conference start moment, such that the EIM application's server terminal 1 initiates a call to at least one of the user A and the to-be-reminded objects before the conference start moment, to establish the teleconference or video conference. Certainly, when the EIM application's client terminal 1 sends the conference reminding message to the to-be-reminded objects via an EIM application's server terminal, since the EIM application's server terminal 1 may obtain the conference reminding message, and acquire the conference start moment therein, the call is initiated to at least one of the user A and the to-be-reminded objects at the conference start moment, to establish the teleconference or video conference, without the need for separately sending the above call booking request or a similar message by the EIM application's client terminal 1.

When the EIM application's server terminal initiates a call, the EIM application's server terminal may initiate the call only to the user A, to establish a teleconference or video conference in which only the user A joins, and the to-be-reminded objects may join in the teleconference or video conference halfway; or the EIM application's server terminal may initiate the call only to a part of the to-be-reminded objects, to establish a teleconference or video conference in which only the part of the to-be-reminded objects join, and the user A and other to-be-reminded objects may join in the teleconference or video conference halfway; or the EIM application's server terminal may initiate the call to all to-be-reminded objects, to establish a teleconference or video conference in which all to-be-reminded objects join, and the user A may join in the teleconference or video conference halfway; or the EIM application's server terminal may initiate the call to the user A and all to-be-reminded objects, to establish a teleconference or video conference in which the user A and all to-be-reminded objects join.

Further, the EIM application's client terminal 1 may determine a conference form, and when the conference form is an online conference, such as a teleconference or video conference, automatically achieve the teleconference or video conference between the user A and the to-be-reminded objects via the above call request or call booking request; or the EIM application's client terminal 1 may show the “Conference initiates automatically” option 79 when the conference form is the online conference, such as the teleconference or video conference, and hide the “Conference initiates automatically” option 79 when the conference form is one of other forms.

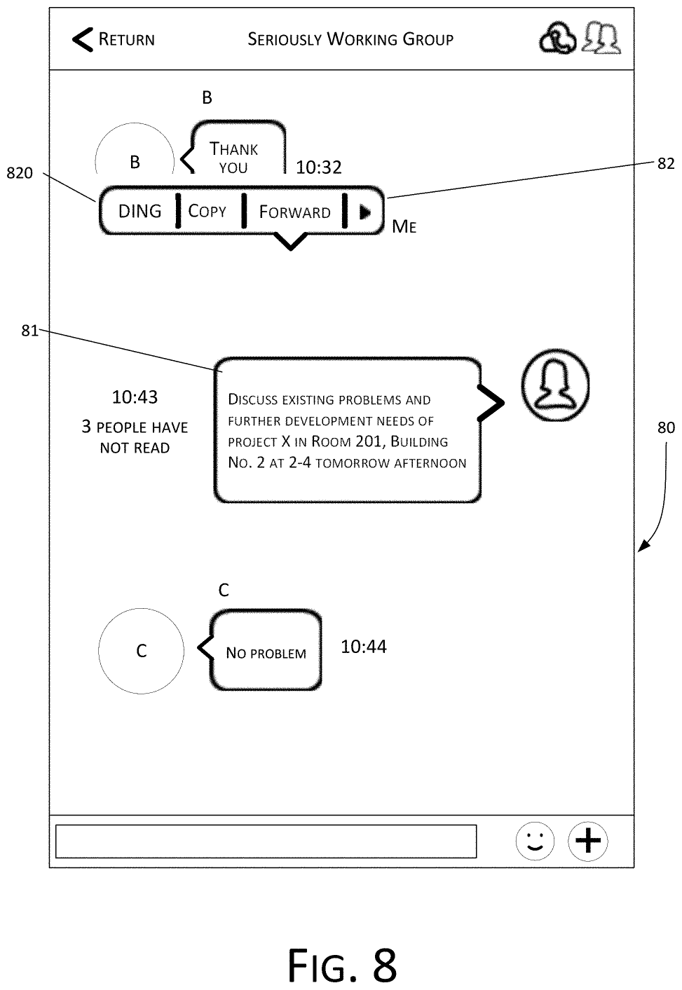

In addition to triggering the identifier “create” 51 shown in FIG. 5, the user A may further create a conference reminding message by other approaches. Assuming that the user A participates in the group communication session shown in FIG. 8 in the EIM application's client terminal 1 (the same applies to the single communication session between the user A and a single contact person), the user A may trigger for any communication message 81 (e.g., click, long press, or heavily press) in a corresponding communication session page 80, such that the EIM application's client terminal 1 displays a function menu 82 for the communication message 81. The function menu 82 includes menu options, such as “DING,” “copy,” and “forward.”

In a circumstance, when detecting that the user A selects a menu option 820 corresponding to the “DING,” the EIM application's client terminal 1 may determine that the user A initiates a user's creating operation for the reminding message, thus switching to the message type selection page 60 shown in FIG. 6, such that the user A further selects a message type of a to-be-created reminding message, and creates the conference reminding message via the new conference page 70 shown in FIG. 7.

In another circumstance, the EIM application's client terminal 1 may actively analyze message content of the communication message 81, or the EIM application's client terminal 1 may initiate an analysis request for the communication message 81 to the EIM application's server terminal, such that the EIM application's server terminal analyzes the message content of the communication message 81, to determine whether the communication message 81 contains event description information of a preset type. For example, when the message content of the communication message 81 is “discuss existing problems and further development needs of project X in Room 201, Building No. 2 at 2-4 tomorrow afternoon,” assuming that the analysis result is the message content containing event time information “2-4 tomorrow afternoon, event location information “Room 201, Building No. 2,” and event theme information “discuss existing problems and further development needs of project X,” then when the user A selects the menu option 820, the EIM application's client terminal 1 may automatically determine that the corresponding reminding message is a conference reminding message, and go to the new conference page 70 shown in FIG. 7 without the need for manually selecting the message type via the message type selection page 60 shown in FIG. 6 by the user A. Further, the EIM application's client terminal 1 may further automatically fill content in the new conference page 70 based on the above analyzed event description information, to simplify operations of the user A and improve the efficiency of creating the conference reminding message.

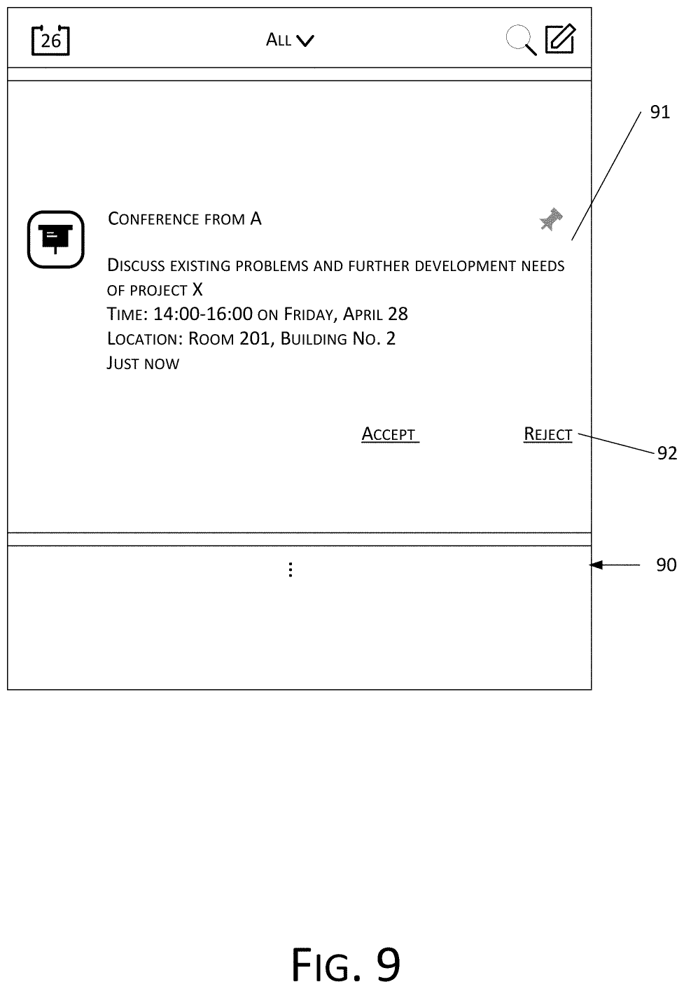

After the user A sends the conference reminding message via the mobile phone 13, the EIM application's client terminals 2 and 3 running on the mobile phones 14 and 15 respectively may receive the conference reminding message, and display the conference reminding message to the user B and the user C. For example, as shown in FIG. 9, the EIM application's client terminal 3 running on the mobile phone 15 may display all reminding messages sent and received by the user C via the reminding message management page 90, such that the user C can view message content 91 of the above reminding message from the user A. At the same time, for the conference reminding message or reminding messages of other event types, a sender not only needs to know whether a receiver has viewed a corresponding conference reminding message, but also, more importantly, would like to know whether the receiver can participate in a relevant conference. Therefore, a response option 92 for the above message content 91 may be further displayed in the reminding message management page 90, including e.g., “accept” and “reject” shown in FIG. 9. When the user C selects the “accept” in the response option 92, then the user C may participate in a conference presented by the user A, and when the user C selects the “reject” in the response option 92, then the user C cannot participate in the conference presented by the user A.

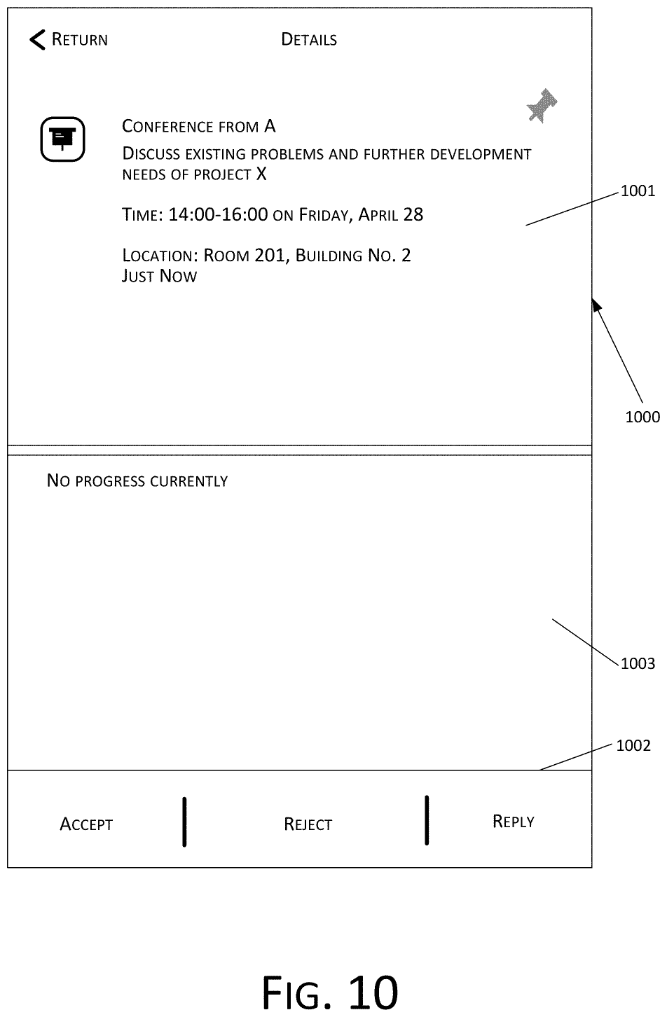

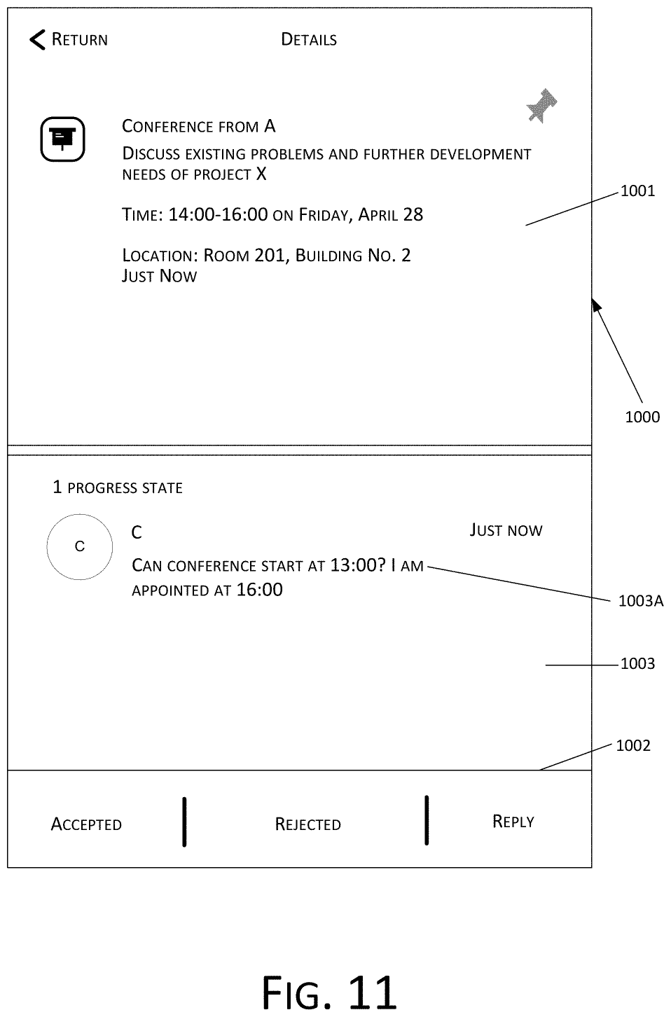

Because concentrated display of all reminding messages sent and received by the user C is required in the reminding message management page 90, in order to enable the user C to view more reminding messages simultaneously on the mobile phone 15, the EIM application's client terminal 3 may minimize a display area occupied by each reminding message, such that the above response option 92 may not always be displayed in the reminding message management page 90, or even the message content 91 may not be fully displayed, and only outline content can be shown. Then, the user C may trigger the message content 91 in the reminding message management page 90, such that the EIM application's client terminal 3 is switched to a reminding message detail page 1000 shown in FIG. 10, which shows the above message content 91 in a content display area 1001 of the reminding message detail page 1000. The reminding message detail page 1000 may further include a function option area 1002. The function option area 1002 may include the above response options 92, such as “accept” and “reject.” When one of the response options 92 is selected, a corresponding option content may change accordingly. For example, when the “reject” is selected, the corresponding response option 92 may change from the “reject” in FIG. 10 to “rejected” in FIG. 11; similarly, when the “accept” is selected, the “accept” may be changed to “accepted.”

In addition, the reminding message detail page 1000 may further include a progress message area 1003 corresponding to a conference reminding message, which is configured to display a progress message related to the conference reminding message, such as a reply message of a sender or a receiver of the conference reminding message for the conference reminding message. Taking the user C as an example, the user C may trigger via a “reply” option in the function option area 1002, to input the reply message for the conference reminding message. For example, as shown in FIG. 11, assuming that message content 1003A of the reply message is “can the conference start at 13:00? I am appointed at 16:00,” the message content 1003A may be displayed in the progress area 1003. Similarly, when the mobile phone 15 receives a reply message sent by other users, corresponding message content may also be displayed in the progress area 1003, for centralized display to the user C. Certainly, a reply message sent by a user will not always be received and viewed by all related communicators of the conference reminding message (i.e., the sender and all receivers of the conference reminding message). For example, the user C may select one or more users of all the above related communicators based on actual situation, for use as objects to which the reply message is to be sent. For example, the EIM application's client terminal 3 may provide a “whisper” option to the user C. When the user C does not select the “whisper” option, the above reply message may be sent only to all related communicators. When the user C selects the “whisper” option, the above reply message may be sent only to the sender of the conference reminding message, i.e., the user A, and other users will not receive the reply message.

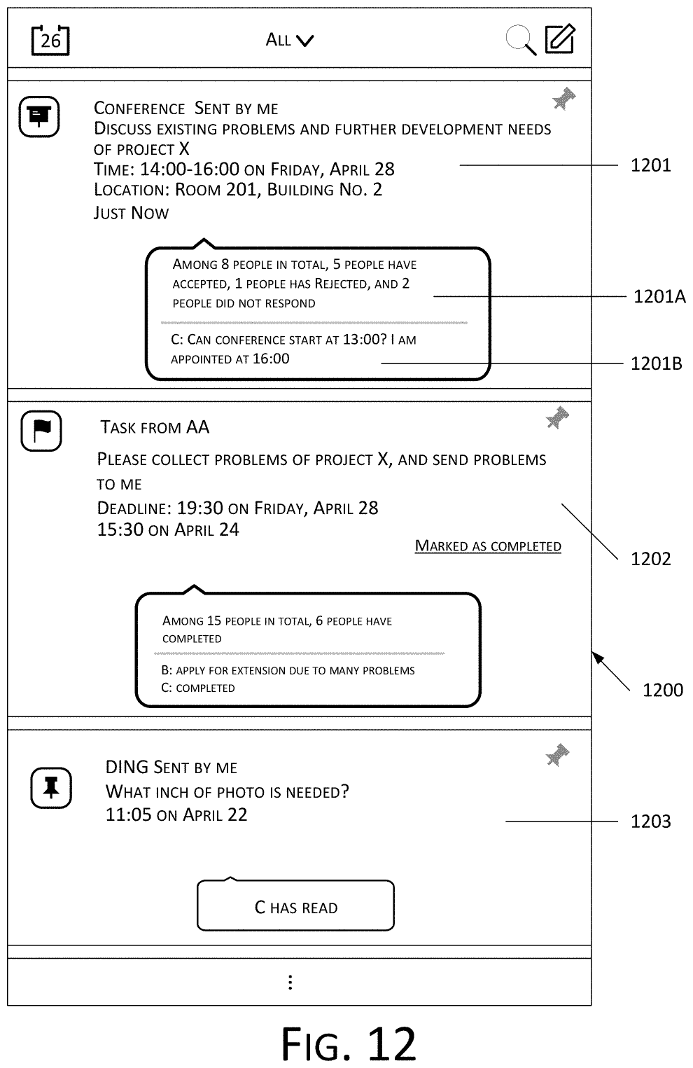

For the user A, progress such as a response status and a reply message, of the to-be-reminded object for the above conference reminding message may be viewed on the mobile phone 13. For example, as shown in FIG. 12, a display area 1201 corresponding to the above-mentioned conference reminding message, a display area 1202 for displaying a task reminding message from a user AA, and a display area 1203 for displaying a DING reminding message sent by the user A are displayed respectively in the reminding message management page 1200 of the EIM application's client terminal 1 running on the mobile phone 13. A response status 1201A of 8 to-be-reminded objects on the conference reminding message may be displayed in the display area 1201. For example, the response status 1201A may be “5 people have accepted the conference reminding message, 1 people has rejected the conference reminding message, and 2 people did not respond,” where “1 people has rejected the conference reminding message” may correspond to the above user C; at the same time, a reply message 1201B related to the conference reminding message may be further displayed in the display area 1201. For example, the reply message 1201B may include the above “can the conference start at 13:00? I am appointed at 16:00” inputted by the user C. Similarly, for the convenience of viewing, the mobile phone 15 may also display the progress area 1003 shown in FIG. 11 and reply content thereof in the reminding message management page 90 shown in FIG. 9 by an approach similar to the embodiment shown in FIG. 12. The description will not be repeated here.

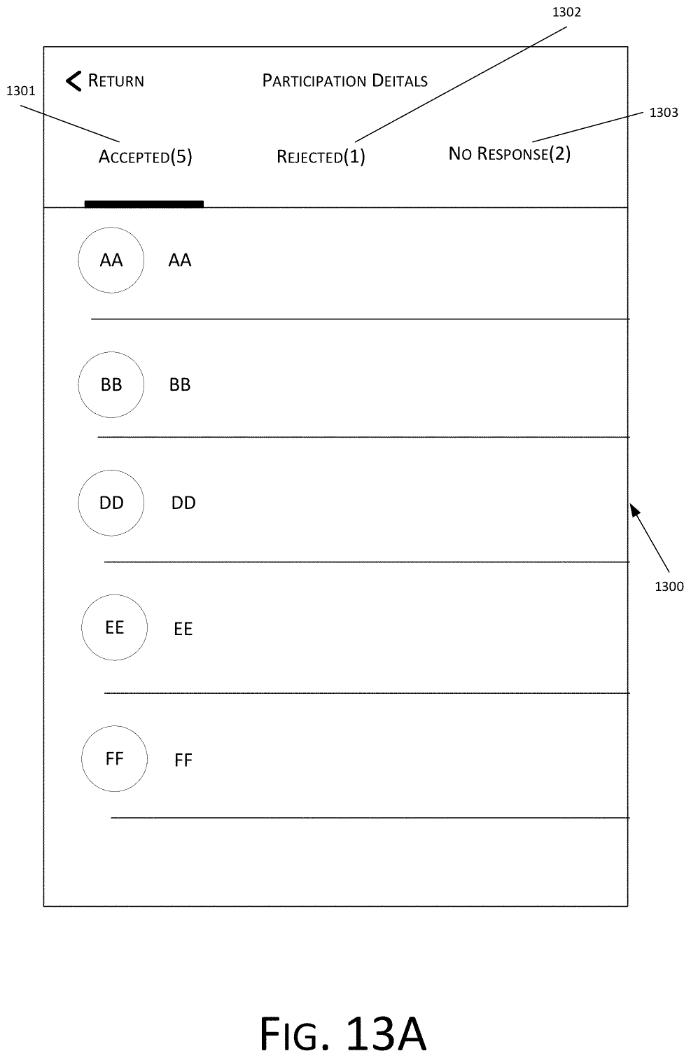

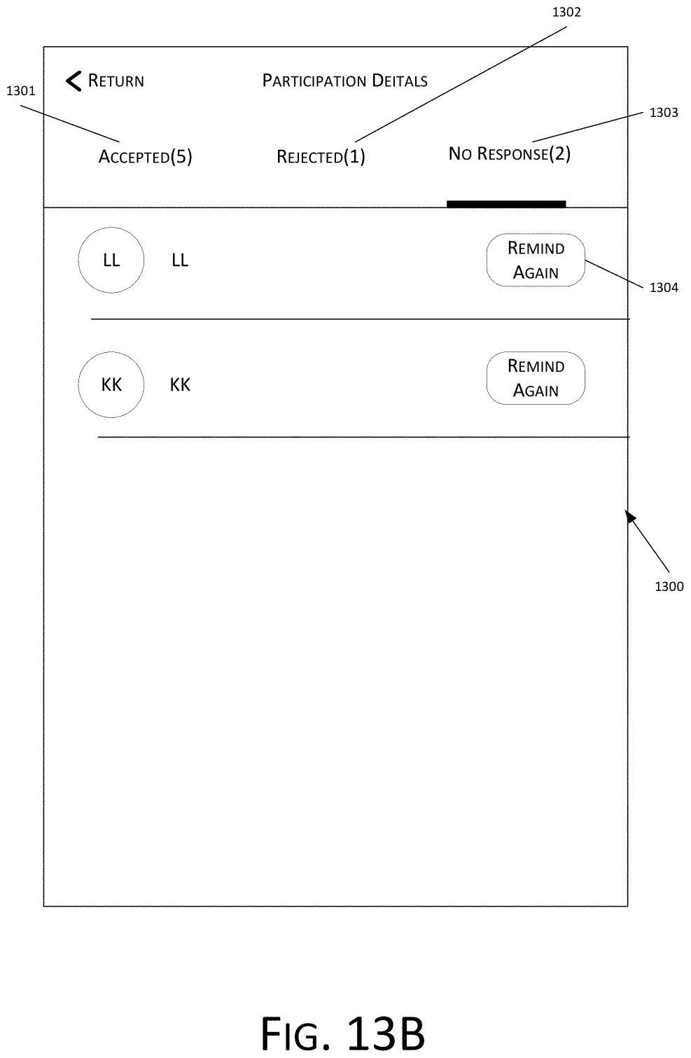

In the reminding message management page 1200 shown in FIG. 12, the response status 1201A may include only general information similar to “5 people have accepted the conference reminding message, 1 people has rejected the conference reminding message, and 2 people did not respond.” The user A may trigger the response status 1201A, such that the EIM application's client terminal 3 displays the response detail page 1300 shown in FIG. 13 A on the mobile phone 15, to view a to-be-reminded object specifically corresponding to each response status in detail. For example, as shown in FIG. 13A, when the user A selects an option 1301 corresponding to “accepted,” the response detail page 1300 may show all users selecting “accept” for the above conference reminding message, such as the user AA, a user BB, a user DD, a user EE, and a user FF. Similarly, when the user A selects an option 1302 corresponding to “rejected,” the response detail page 1300 may show all users selecting “reject” for the above conference reminding message, e.g., the above user C. When the user A selects an option 1303 corresponding to “no response,” as shown in FIG. 13B, the response detail page 1300 may show users having not responded to the above conference reminding message yet, such as a user LL, and a user KK. The response detail page 1300 may further show a corresponding “re-remind” option 1304 for each “no responding” user. When the user A selects, e.g., the “re-remind” option 1304 corresponding to the user LL, the mobile phone 13 may resend the above conference reminding message to the user LL, to remind the user LL to respond.

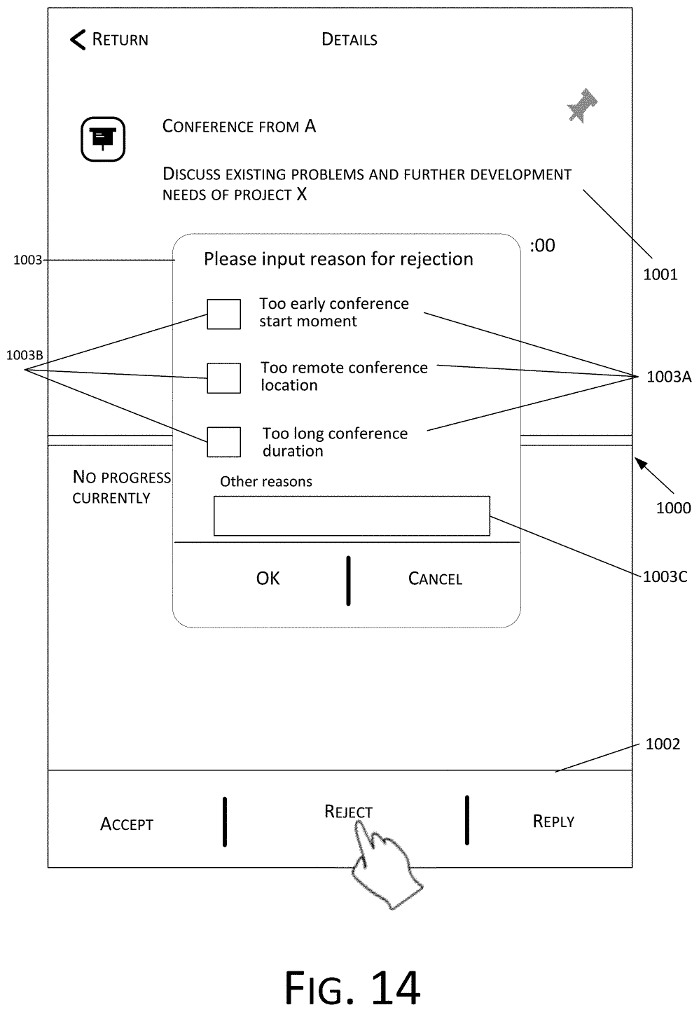

When the user A finds that the response status of the user C for the above conference reminding message is “reject,” the user A cannot know the reason for rejection of the user C therefrom. The user C may send the reply message 1201B shown in FIG. 12 to the user A for explanation to the user A, but can neither guarantee that the user C can send the reply message for explanation each time, nor guarantee that other users will also send reply messages for explanation, such that the user A needs to query by an additional approach, such as sending a reply message or instant message to the user C, or calling the user C, thereby resulting in complex operations and low efficiency. Thus, as shown in FIG. 14, when the user C selects a “reject” option, the EIM application's client terminal 3 running on the mobile phone 15 may display a reason input window 1003, such that the user C inputs at least one reason for rejection. In an embodiment, the input operation for the reason for rejection may be imperative, i.e., only after the user C inputs at least one reason for rejection, can the EIM application's client terminal 3 allow the user C to select the “reject” option. The reason input window 1003 may show at least one predefined reason 1003A for rejection, such that the user C triggers a selection box 1003B corresponding to the predefined reason 1003A for rejection to select the reason. The user C may also manually input the reason for rejection through an input box 1003C. Certainly, the reason input window 1003 may show at least one of the predefined reasons 1003A for rejection and the input box 1003C, as long as the reason for rejection can be provided by the user C.

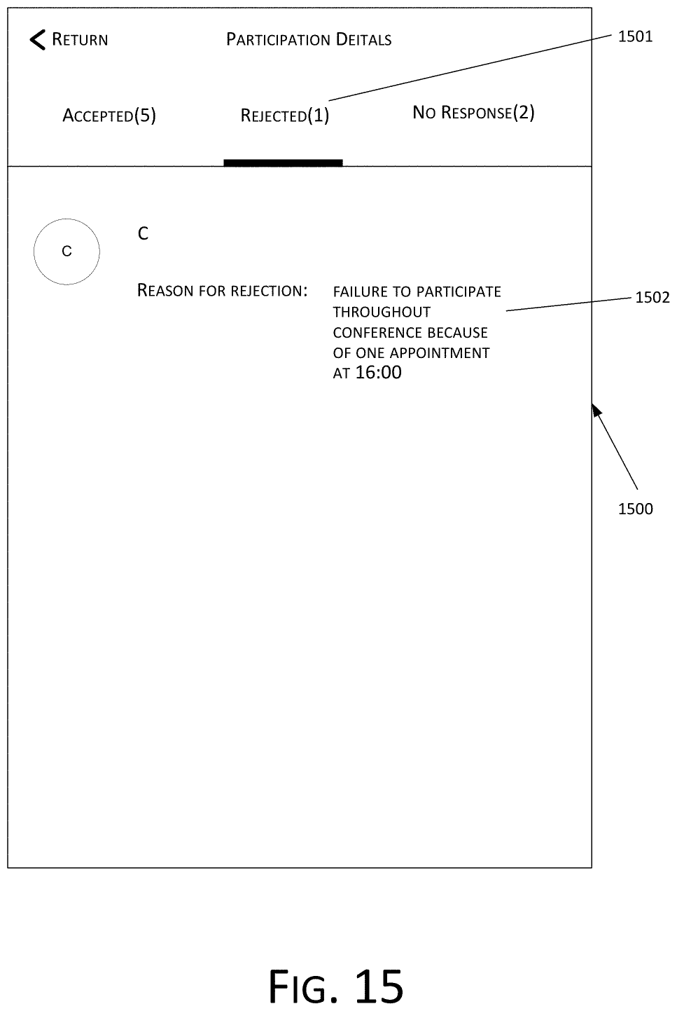

Accordingly, as shown in FIG. 15, the user A may select an option 1501 corresponding to “rejected” in the response detail page 1500, to view a to-be-reminded object selecting “reject” and a reason 1502 for rejection thereof. For example, the reason 1502 for rejection provided by the user C may be “failure to participate throughout the conference because of an appointment at 16:00.” Then, after viewing the reason 1502 for rejection, the user A may make arrangement or adjustment accordingly, for example, advance or delay conference time based on the needs of the user C.

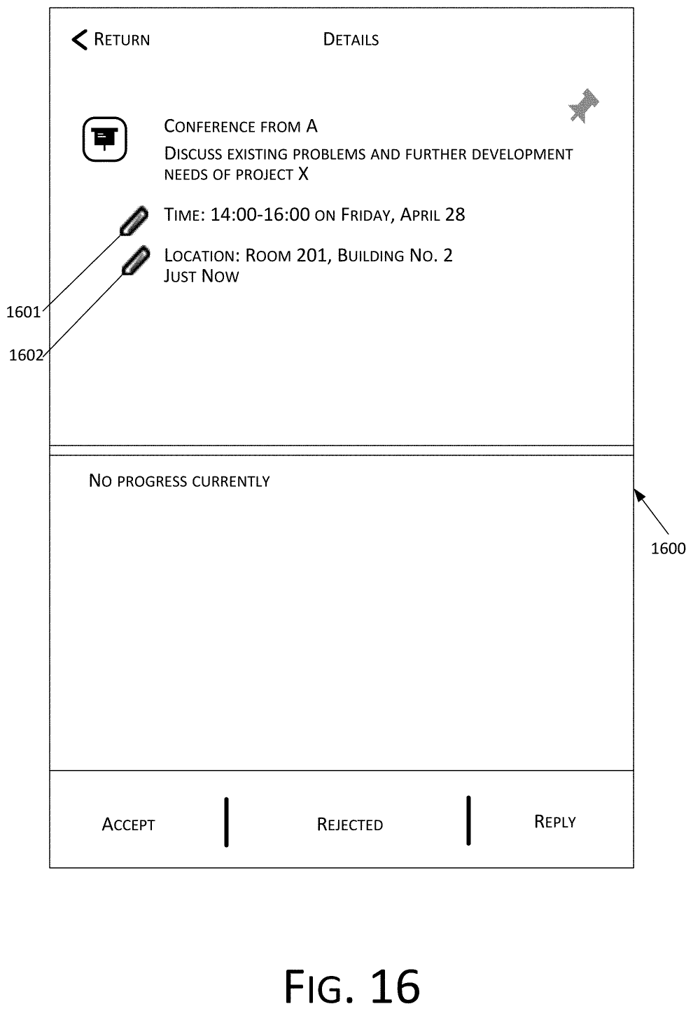

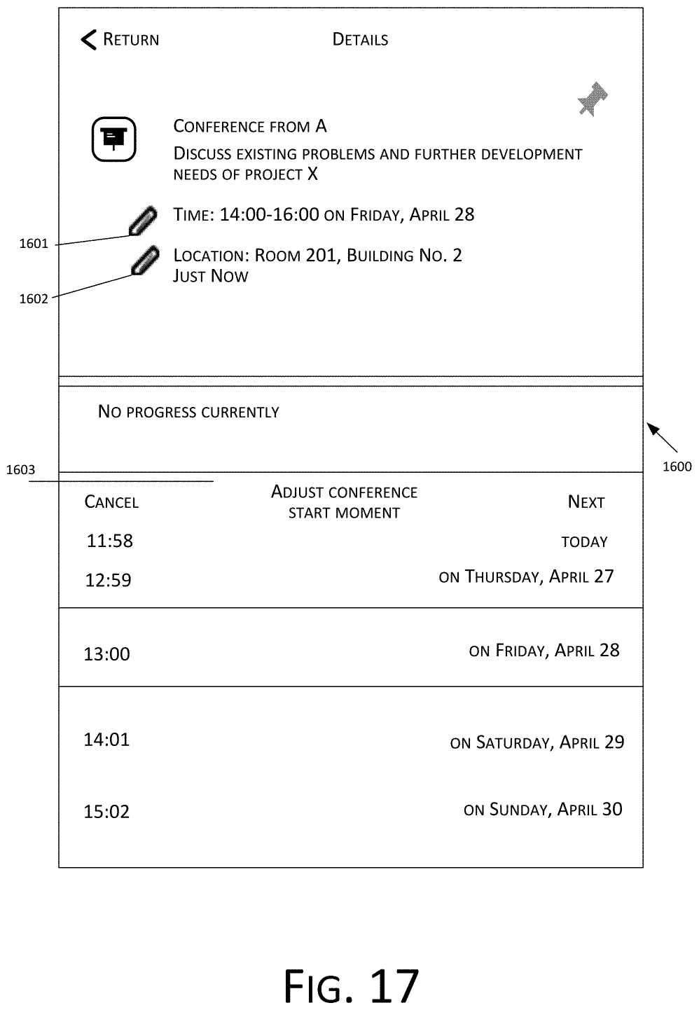

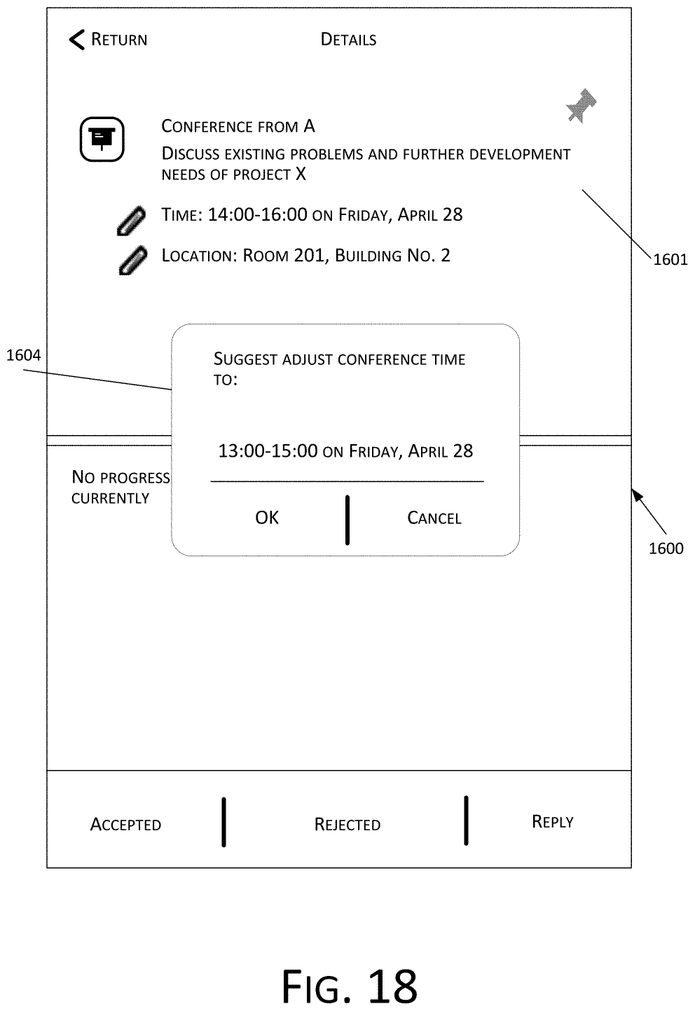

In addition to providing the reason for rejection, when the to-be-reminded object holds a different view on conference description information in a conference reminding message, the to-be-reminded object may further present an adjustment request on the corresponding conference description information, to achieve corresponding adjustment. As shown in FIG. 16, in a reminding message detail page 1600 shown in the mobile phone 15, a corresponding adjustment identifier 1601, and a corresponding adjustment identifier 1602 may be shown respectively on the left side of conference time information and conference location information. Taking adjustment of the conference time information as an example, when receiving a triggering operation of the user C for the adjustment identifier 1601, the EIM application's client terminal 3 running on the mobile phone 15 may show a time adjustment option 1603 shown in FIG. 17, such that the user C may present an adjustment suggestion for the conference time information. Specifically, the user C may first define an adjusted conference start moment in the reminding message detail page 1600 shown in FIG. 17, and then further define an adjusted conference end moment by triggering “next,” thus obtaining desired adjusted conference time information for the user C. The mobile phone 15 may initiate an adjustment request for the adjusted conference time information to the user A; or the mobile phone 15 may first show a confirmation window 1604 shown in FIG. 18 to the user C, and the user C, after confirmation, initiates the adjustment request to the user A.

In the reminding message detail page 1600 shown in FIG. 16, the adjustment identifiers 1601-1602 may be shown only after the user C confirms to select “reject,” such that the user C further sends the adjustment request. Certainly, even if the user C does not select “accept” or “reject,” or the user C has selected “accept,” the above adjustment identifiers 1601-1602 can still be shown, such that the user C further sends the adjustment request.

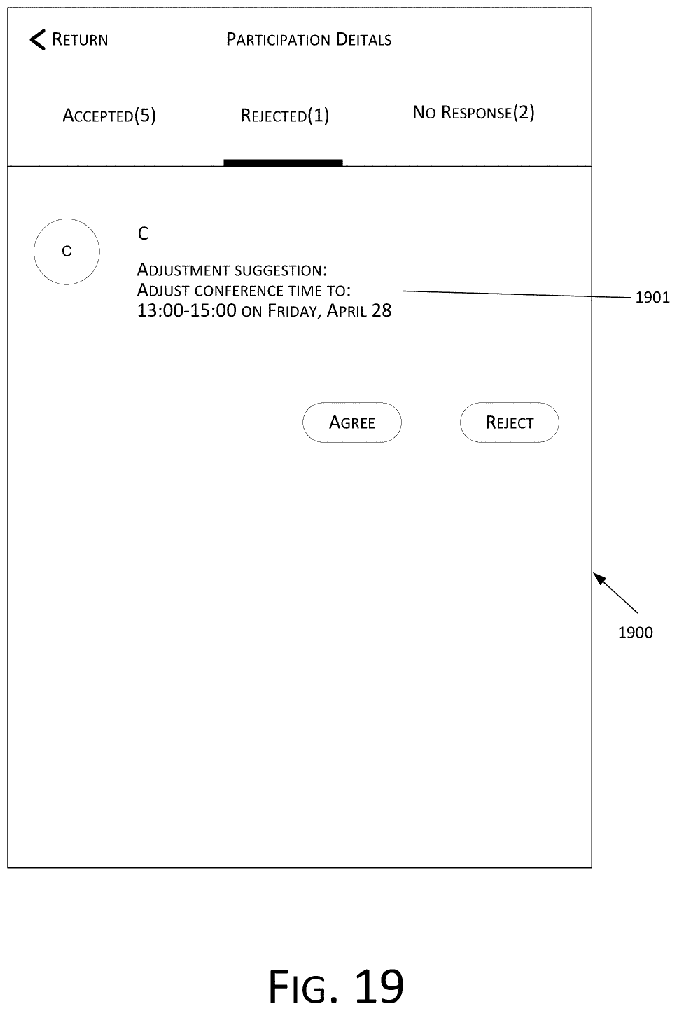

Assuming that the user C selects “reject,” the user A may view request content 1901 of the adjustment request sent by the user C in a “rejected” sub-page of a response detail page 1900 shown in FIG. 19. For example, the request content 1901 may include “adjustment suggestion: adjusting conference time to 13:00-15:00 on Friday, April 28.” Certainly, as mentioned above, if the user C selects “accept,” the user A may view the request content of the adjustment request sent by the user C in an “accepted” sub-page of the response detail page 1900. If the user C does not select “accept” or “reject” yet, the user A may view the request content of the adjustment request sent by the user C in a “no responding” sub-page of the response detail page 1900.

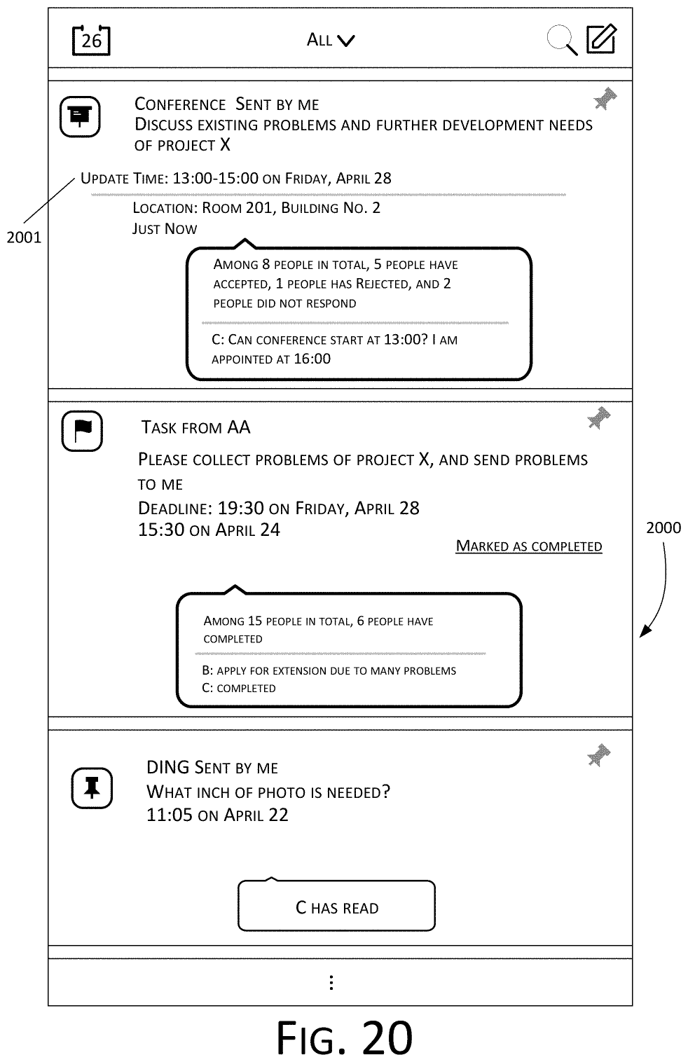

In the response detail page 1900 shown in FIG. 19, a processing option for the request content 1901 may be shown, including “agree,” “reject,” and the like. When the user A selects an option “agree,” the user A agrees on adjustment for conference time information suggested by the user C, and then the EIM application's client terminal 1 running on the mobile phone 13 may not only adjust the conference time information in previously sent conference reminding message based on adjusted conference time information, but also send a corresponding adjustment instruction to a to-be-reminded object of the conference reminding message, such that the EIM application's client terminal running on an electronic device used by each to-be-reminded object, in response to the adjustment instruction: adjusts conference time information in previously received conference reminding message based on the above adjusted conference time information indicated by the adjustment instruction. For example, as shown in FIG. 20, in a reminding message management page 2000 shown in the mobile phone 13, the conference time information may be adjusted from the above “16:00-18:00 on Friday, April 28” to “13:00-15:00 on Friday, April 28,” and “update,” “underline,” or a similar reminding message 2001 may be shown near the adjusted conference time information, for viewing by the user A. Similarly, on the mobile phone 14 and the mobile phone 15 used by to-be-reminded objects, such as the user B, and the user C, the running EIM application's client terminal 2 and EIM application's client terminal 3 may also adjust the conference time information from the above “16:00-18:00 on Friday, April 28” to “13:00-15:00 on Friday, April 28” based on the above adjustment instruction, and show “update,” “underline,” or a similar reminding message near the adjusted conference time information.

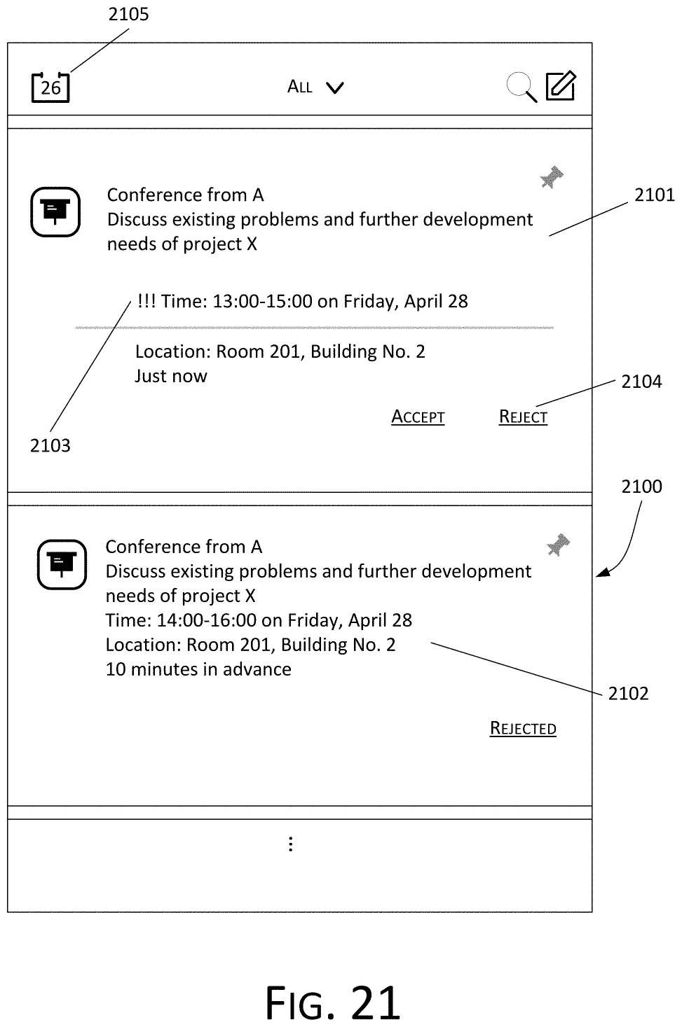

Certainly, in addition to adjusting the previous conference reminding message via the adjustment instruction, the EIM application's client terminal 1 running on the mobile phone 13 may further send a new conference reminding message to each to-be-reminded object based on the adjusted conference time information. The new conference reminding message contains the adjusted conference time information. For example, as shown in FIG. 21, in the reminding message management page 2100 shown in the mobile phone 15, a new reminding message 2101 received by the mobile phone 15 and a previously received reminding message 2102 may be shown; for conference time information in the new reminding message 2101, “!!!,” “underline,” or a similar reminding message 2103 may be used, such that the user C is easier to pay attention to adjustment of the conference time information. Meanwhile, for the new reminding message 2101, a response option 2104 for the reminding message may be shown, for selection by the user C.

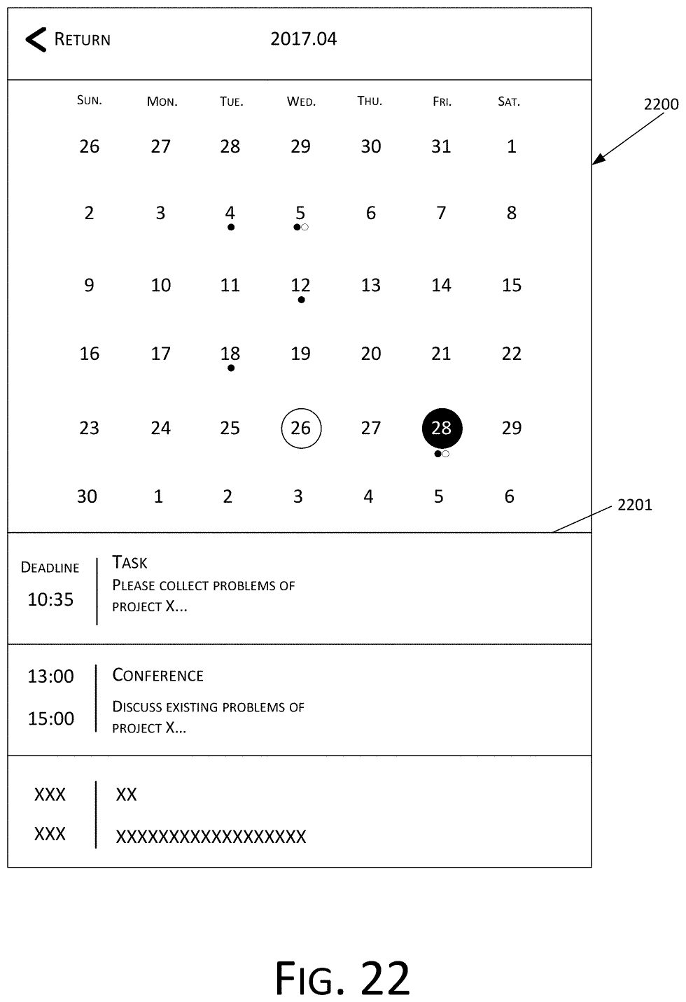

In order to facilitate implementing enterprise event management within an enterprise, the EIM application's client terminal of the present disclosure may provide a calendar management function. For example, as shown in FIG. 22, by showing a management calendar 2200, and showing daily related enterprise events on the management calendar 2200, users may quickly grasp processing situation of the enterprise events, to facilitate reasonable arrangement of subsequent work. Taking the management calendar 2200 shown in FIG. 22 as an example, by adding event reminding information for each date with an enterprise event, the users may quickly know that there is a related enterprise event on a corresponding date. For example, a black dot is added to the bottom of “Apr. 4, 2017,” “Apr. 5, 2017,” “Apr. 12, 2017,” and “Apr. 18, 2017” to indicate that there is a task event. For a conference reminding message sent by the user A to the user C, equivalent to creating a new enterprise event-conference event, in the above embodiments, for both the EIM application's client terminal 1 running on the mobile phone 13 used by the user A, and the EIM application's client terminal 3 running on the mobile phone 15 used by the user C, a corresponding conference event may be created for the conference reminding message in the corresponding management calendar. Taking the user C as an example, a calendar page entry 2105 may be provided on the top left corner of the reminding message management page 2100 shown in FIG. 21. When detecting that the user C triggers the calendar page entry 2105, the management calendar 2200 shown in FIG. 22 may be switched to, such that the user C views or edits an existing enterprise event, or manually creates a new enterprise event. As shown in FIG. 22, because the conference reminding message received by the mobile phone 15 contains the conference time information “13:00-15:00 on Friday, April 28” shown in FIG. 21, a conference event related to “Apr. 28, 2017” may be created. To distinguish from the above task events and enterprise events of other types, a white dot may be added to the bottom of “28” for the conference event, such that the user C fast distinguishes the conference event from other enterprise events. Similarly, there is also a black dot and a white dot at the bottom of “Apr. 5, 2017,” indicating that there are both a task event and a conference event on that day.

When detecting that a date is selected, for example, assuming that “Apr. 28, 2017” is selected in FIG. 22, an enterprise event existing on that date may be shown. For example, description information of an event task (corresponding to the black dot at the bottom of “28”) and a conference event (corresponding to the white dot at the bottom of “28”) existing on “Apr. 28, 2017” may be shown in a display area 2201 in the lower part of the management calendar 2200. The description information may be abstract information shown in FIG. 22 (when information of an abstract is selected, corresponding detail information may be further shown), or the description information may be detail information. When “Apr. 28, 2017” is selected, the corresponding numeral “28” may be highlighted to be distinguished from other dates. For example, the numeral 28 is adjusted to white and additionally provided with black background in FIG. 22. Meanwhile, a current date may also be highlighted by an approach different from the selected date and other dates. For example, a circle may be added to the peripheral of “Apr. 26, 2017.”

When displaying the enterprise event existing on the selected date, type prompt information for the enterprise event may be shown, such as a word “task” corresponding to the task event, and a word “conference” corresponding to the conference event shown in FIG. 22. In addition, the type prompt information may be further matched with the above enterprise event prompt information, such as the black dot and the white dot in the management calendar. For example, by using identical or similar display attributes for the type prompt information and the enterprise event prompt information, the user can obtain association between the two from visual perception, thus contributing to improving the user experience. For example, the display attributes may include color, gray scale, transparency, and the like, which are not limited in the present disclosure.

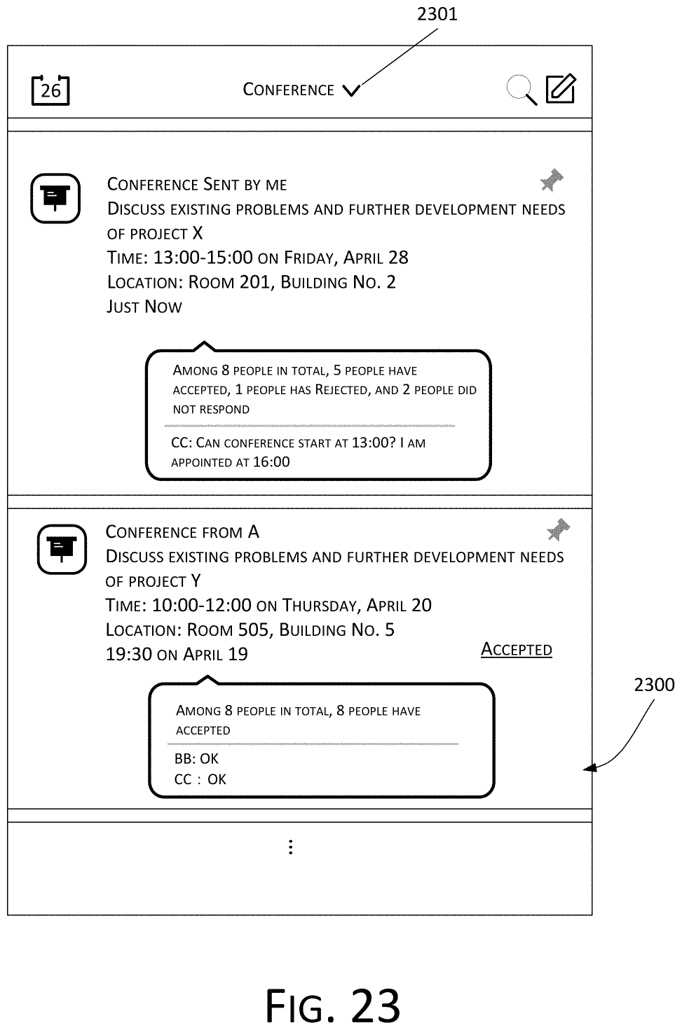

In the technical solution of the present disclosure, the EIM application's client terminal may support reminding messages of a plurality of types, such as the above “conference” type, “task” type, and “DING” type. Because the message type defined in the reminding message management page 2000 shown in FIG. 20 is “all,” reminding messages of all types, such as “conference,” “task,” and “DING,” can be displayed in the reminding message management page 2000. In a reminding message management page 2300 shown in FIG. 23, the message type may be defined as “conference” by triggering a type modification option 2301, thus filtering reminding messages of the “conference” type, and the reminding messages of the “conference” type are shown only in the reminding message management page 2300, to facilitate quickly viewing. Certainly, FIG. 23 only schematically shows the reminding message management page 2300 that may be shown in the EIM application's client terminal 1 running on the mobile phone 13. Likewise, the EIM application's client terminal 2 running on the mobile phone 14 and the EIM application's client terminal 3 running on the mobile phone 15 can achieve similar reminding message filtering and displaying. The description will not be repeated here.

In the above embodiment, assuming that the user A sends the conference reminding message to the mobile phone 14 used by the users B and the mobile phone 15 used by the user C via the EIM application's client terminal 1 running on the mobile phone 13, the user B and the user C view, e.g., the corresponding conference reminding message respectively via the EIM application's client terminal 2 running on the mobile phone 14 and the EIM application's client terminal 3 running on the mobile phone 15, to achieve effective reminding for a conference or other events. In practice, the EIM application's client terminal not only includes a mobile terminal, but also may further include a PC terminal, i.e., the user A may send the conference reminding message to the user B and the user C via the EIM application's client terminal running on the PC, and the user B and the user C may also receive the conference reminding message via the EIM application's client terminal running on the PC, and achieve other functions in the above embodiments.

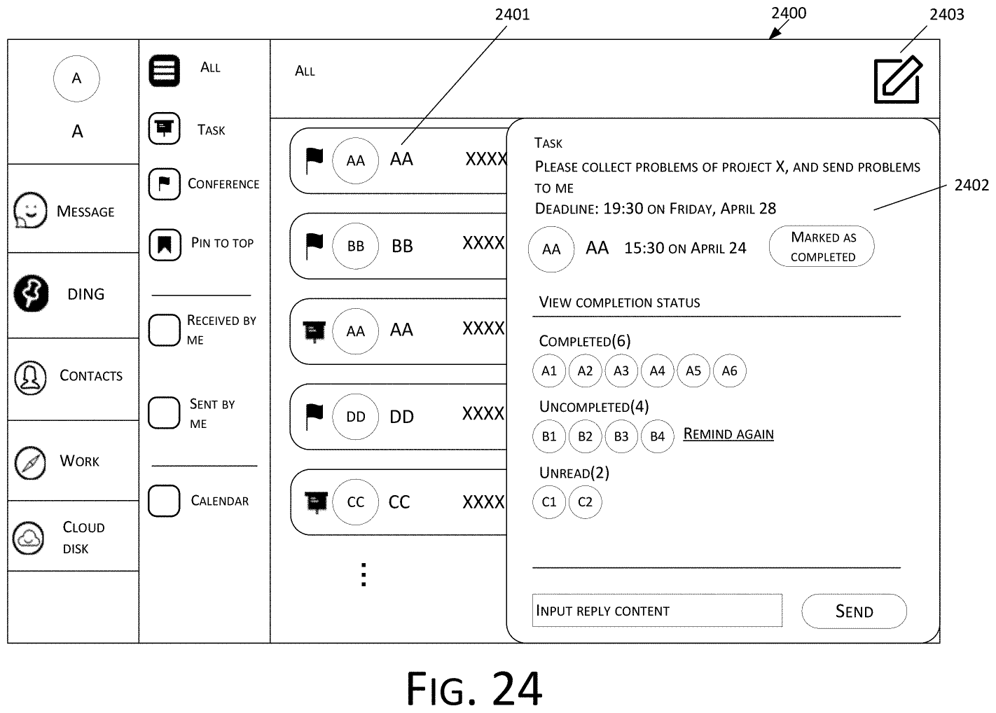

Assuming that FIG. 24 shows an operation interface 2400 of the EIM application's client terminal of the PC terminal used by the user A, the user A may display function options in a second column from the left side on the operation interface 2400 by selecting an option “DING” in function options in a leftmost column. The user A may further display all reminding messages received and sent by the user A on the operation interface 2400 by selecting an option “all” of the function options in the second column, and when the user A further selects a reminding message 2401, the operation interface 2400 may show a rightmost reminding message detail interface 2402. The reminding message detail interface 2402 is used for displaying message content of the reminding message 2401.

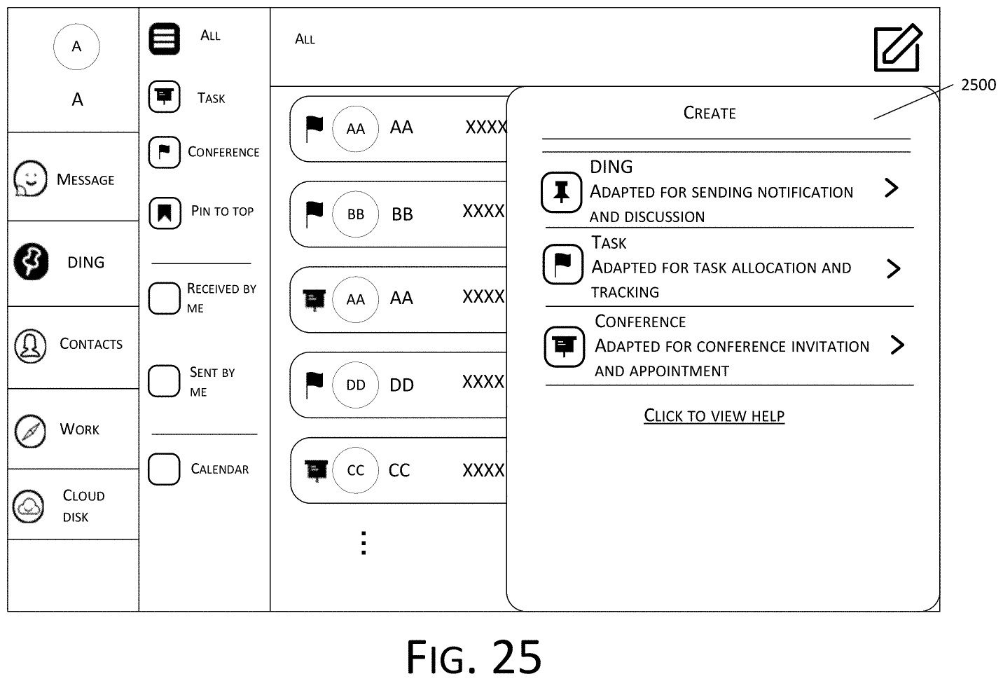

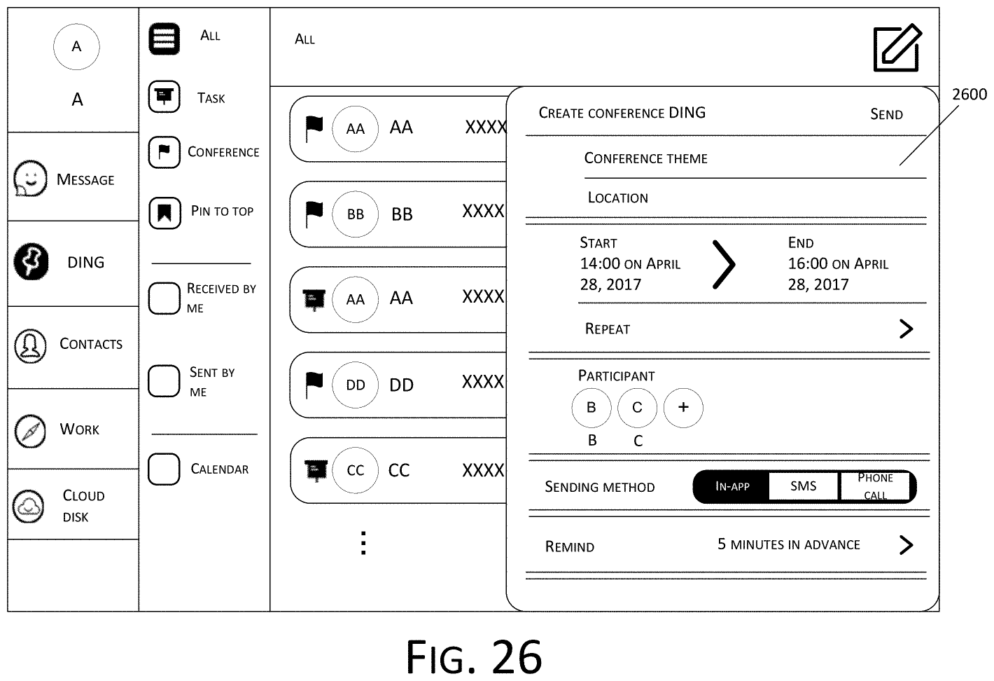

The operation interface 2400 may be provided with an identifier “create” 2403. When detecting that the user A triggers the identifier “create” 2403 (e.g., by clicking a mouse cursor), a message type selection page 2500 shown in FIG. 25 may be shown; where, when the user A selects a “conference” type, a new conference page 2600 shown in FIG. 26 may be further shown, thereby creating a reminding message of the conference type. In practice, the above creating process is similar to a process of creating a conference reminding message by the user A via the mobile phone 13 shown in FIGS. 5-7. The description will not be repeated here. Likewise, like the embodiment shown in FIG. 8, the user A may create the conference reminding message by triggering a communication message on the operation interface 2400 of the PC terminal. The description will not be repeated here.

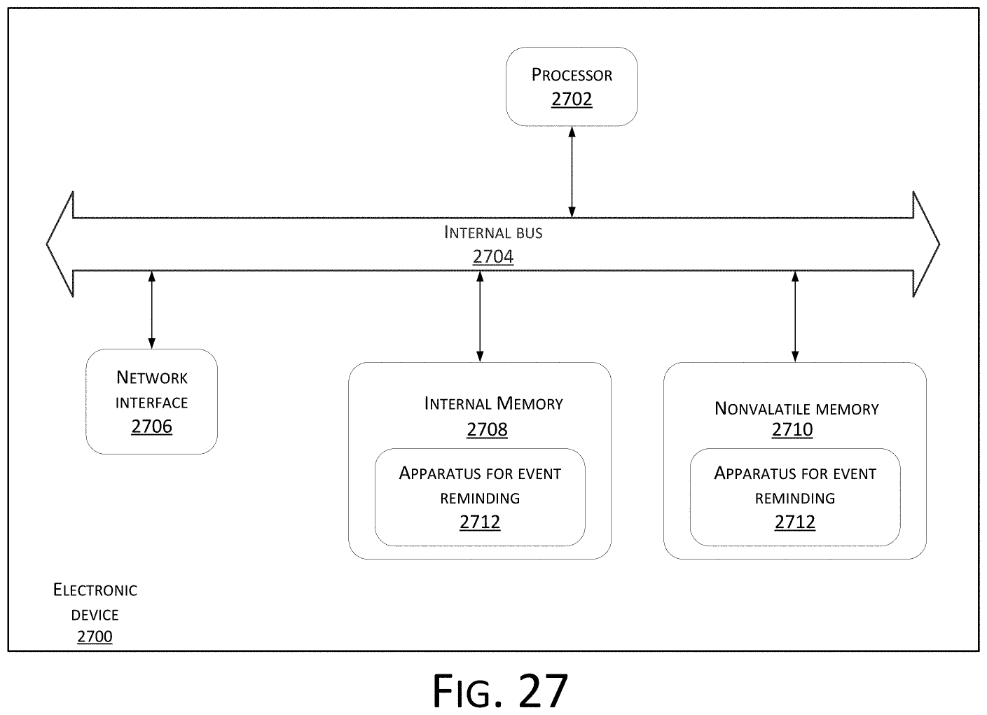

FIG. 27 is a schematic structural diagram of an electronic device 2700 according to an exemplary embodiment of the present disclosure. Referring to FIG. 27, at the hardware level, the electronic device 2700 includes a processor 2702, an internal bus 2704, a network interface 2706, an internal memory 2708, and a nonvolatile memory 2710, and certainly, may further include hardware required for other services. The processor 2702 reads a corresponding computer program from the nonvolatile memory 2710 into the internal memory 2708, and then runs the computer program to form an apparatus for event reminding 2712 in the logical level. Certainly, the present disclosure includes not only a software implementation approach, but also other implementation approaches, such as a logic device, or a combination of hardware and software, i.e., an executing body of the following processes is not limited to each logical unit, and may further be hardware or the logic device. Both the internal memory 2708 and the non-volatile memory 2710 are examples of computer readable media.

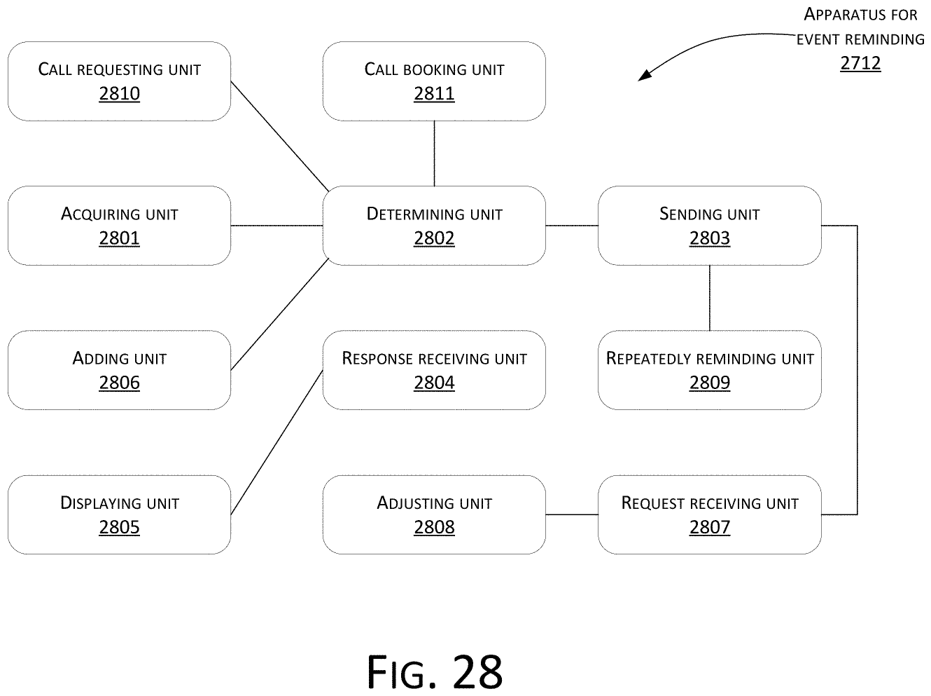

Referring to FIG. 28, the apparatus for event reminding 2712 may include:
a receiving unit 2801 configured to receive an instruction for generating a reminding message for an event type;
a determining unit 2802 configured to determine a to-be-reminded object and event description information corresponding to the event type; and
a sending unit 2803 configured to send a reminding message to the to-be-reminded object, the reminding message containing the event description information.

For example, the receiving unit 2801 is specifically configured to:
make the client terminal receive a user's creating operation for the reminding message and a user's selecting operation for type information of the reminding message; and
make the client terminal determine that the instruction for generating a reminding message is received when the type information selected by the user's selecting operation is an event type.

For example, the receiving unit 2801 is specifically configured to:
make the client terminal receive a user's triggering operation for a communication message, the user's triggering operation being used for instructing the client terminal to convert the communication message into a reminding message; and
make the client terminal determine that the instruction for generating a reminding message is received when identifying that message content of the communication message contains event description information of a preset type.

For example, the determination unit 2802 is specifically configured to:
make the client terminal extract the event description information of a preset type contained in the message content and make the client terminal determine a communicator related to the communication message as the to-be-reminded object.

For example, the event description information includes at least one of the following items:
event theme information, event location information, event form information, and event time information.

For example, the sending unit 2803 is specifically configured to:
make the client terminal send the reminding message at a default or user-defined sending moment in accordance with a default or user-defined message type.

For example, the apparatus for event reminding 2712 further includes:
a response receiving unit 2804 configured to receive a response message returned by the to-be-reminded object, the response message containing acceptance status information of the to-be-reminded object for the event description information; and
a displaying unit 2805 configured to display the to-be-reminded object and the corresponding response message associatively.

For example, when the acceptance status information is “reject,” the response message further includes: a reason for rejection.

For example, the apparatus for event reminding 2712 further includes:
an adding unit 2806 configured to add a corresponding event in a management calendar of the communication application based on the event description information.

For example, the apparatus for event reminding 2712 further includes:
a request receiving unit 2807 configured to receive an adjustment request presented by the to-be-reminded object for at least one item of the event description information; and
an adjusting unit 2808 configured to, when receiving a user's confirming operation for the adjustment request, send an adjustment instruction for the reminding message to the to-be-reminded object based on adjusted event description information, or send a new reminding message to the to-be-reminded object based on the adjusted event description information.

For example, the apparatus for event reminding 2712 further includes:
a repeatedly reminding unit 2809 configured to, when failing to receive a response message returned by the to-be-reminded object within a preset time length after sending the reminding message, resend the reminding message to the to-be-reminded object, or display a repeated reminding option for the to-be-reminded object, to resend the reminding message to the to-be-reminded object when receiving a user's triggering operation for the repeated reminding option.

For example, the reminding message contains a default or user-defined reminding time point and a default or user-defined reminding action, such that the to-be-reminded object is reminded of an event at the reminding time point based on the reminding action, and reminding content is related to the event description information.

For example, the apparatus for event reminding 2712 further includes:
a call requesting unit 2810 configured to initiate, make the client terminal, based on an event start moment contained in the event description information, a call request for the to-be-reminded object at the event start moment, to establish an audio connection or video connection.

For example, the apparatus for event reminding 2712 further includes:
a call booking unit 2811 configured to initiate a call booking request to a server terminal based on the event start moment contained in the event description information, the call booking request being used for instructing the server terminal to initiate a call to at least one of the client terminal and the to-be-reminded object at the event start moment, to establish an audio connection or video connection.

For example, the sending unit 2803 is specifically configured to send the reminding message to a server terminal, such that the server terminal sends the reminding message to the to-be-reminded object;
where the reminding message is used for instructing the server terminal to: initiate, based on an event start moment contained in the event description information, a call to at least one of the client terminals and the to-be-reminded object at the event start moment, to establish an audio connection or video connection.

For example, the event description information contains event form information. The event form information indicates that the corresponding event is a teleconference or video conference.

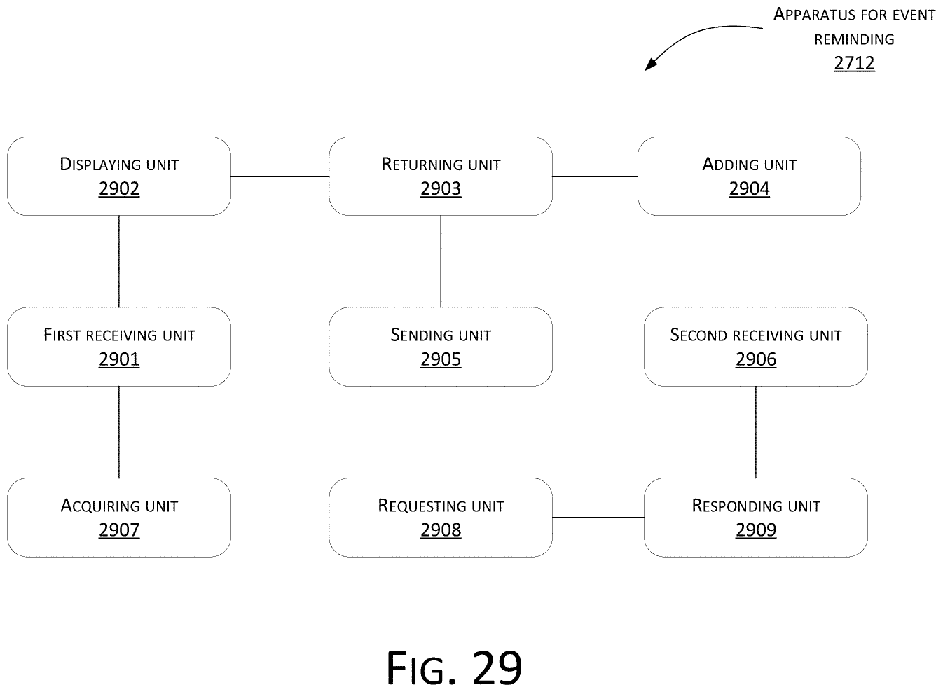

Referring to FIG. 29, the apparatus for event reminding 2712 may include:
a first receiving unit 2901 configured to receive a reminding message of an event type;
a displaying unit 2902 configured to display event description information contained in the reminding message; and
a returning unit 2903 configured to return a corresponding response message to a sender of the reminding message based on a received user's triggering operation for the event description information, the response message including acceptance status information for the event description information indicated by the user's triggering operation.

For example, the returning unit 2903 is specifically configured to:
when the acceptance status information indicated by the user's triggering operation is “agree,” directly return the response message; and
when the acceptance status information indicated by the user's triggering operation is “reject,” further acquire a corresponding reason for rejection, add the reason for rejection to the response message, and return the resulting response message to the sender.

For example, apparatus for event reminding 2712 further includes:
an adding unit 2904 configured to, when the acceptance status information indicated by the user's triggering operation is “agree,” add a corresponding event in a management calendar of a communication application based on the event description information.

For example, apparatus for event reminding 2712 further includes:
a sending unit 2905 configured to, when the acceptance status information indicated by the user's triggering operation is “reject,” further acquire adjustment information for at least one item of the event description information, and send an adjustment request containing the adjustment information to the sender; and
a second receiving unit 2906 configured to receive a new reminding message returned by the sender, the new reminding message containing event description information adjusted based on the adjustment request; or make the client terminal receive an adjusting instruction returned by the sender based on the adjusted event description information, and adjust the event description information in the reminding message based on the adjusting instruction.

For example, apparatus for event reminding 2712 further includes:
an acquiring unit 2907 configured to acquire a reminding time point and a reminding action contained in the reminding message;
a requesting unit 2908 configured to initiate an event reminding request corresponding to the reminding time point and the reminding action to a server terminal; and
a responding unit 2909 configured to respond to an event reminding event initiated by the server terminal at the reminding time point in the reminding action.

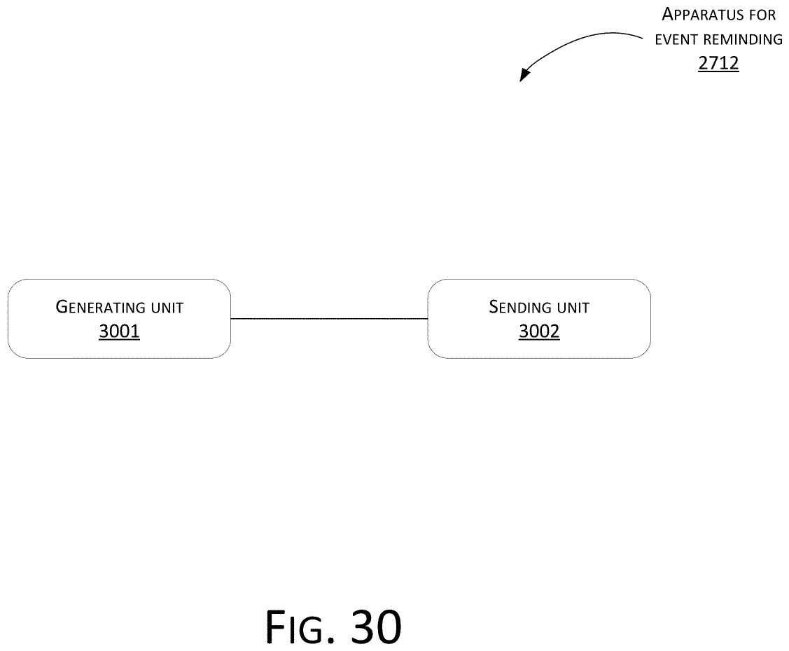

Referring to FIG. 30, apparatus for event reminding 2712 for event reminding may include:
a generating unit 3001 configured to generate a reminding message based on event description information and a to-be-reminded object; and
a sending unit 3002 configured to send the reminding message to the to-be-reminded object, the reminding message containing the event description information.

For example, the generating unit 3001 is specifically configured to:
make the client terminal receive a user's creating operation for the reminding message and a user's selecting operation for type information of the reminding message; and
when the type information selected by the user's selecting operation is an event type, make the client terminal generate the reminding message based on the event type.

For example, the generating unit 3001 is specifically configured to:
make the client terminal receive a user's triggering operation for a communication message, the user's triggering operation being used for instructing the client terminal to convert the communication message into a reminding message; and
make the client terminal generate the reminding message when identifying that message content of the communication message contains event description information of a preset type.

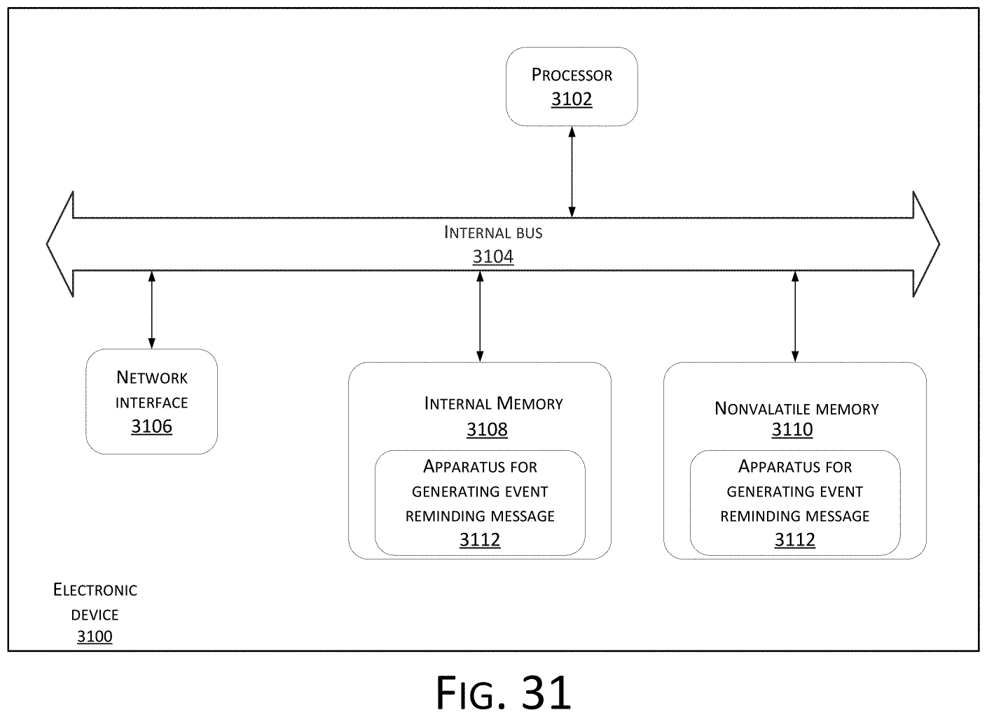

FIG. 31 is a schematic structural diagram of an electronic device 3100 according to an exemplary embodiment of the present disclosure. Referring to FIG. 31, at the hardware level, the electronic device 3100 includes a processor 3102, an internal bus 3104, a network interface 3106, an internal memory 3108, and a nonvolatile memory 3110, and certainly, may further include hardware required for other services. The processor 3102 reads a corresponding computer program from the nonvolatile memory 3110 into the internal memory 3108, and then runs the computer program to form an apparatus for generating an event reminding message 3112 in the logical level. Certainly, the present disclosure includes not only a software implementation approach, but also other implementation approaches, such as a logic device, or a combination of hardware and software, i.e., an executing body of the following processes is not limited to each logical unit, and may further be hardware or the logic device. Both the internal memory 3108 and the non-volatile memory 3110 are examples of computer readable media.

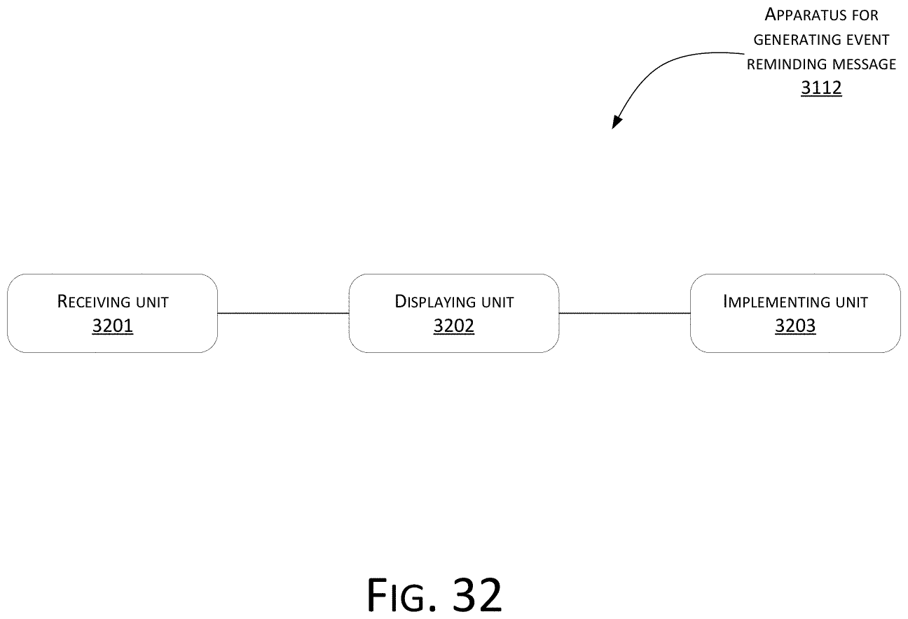

Referring to FIG. 32, the apparatus for generating an event reminding message 3112 may include:
a receiving unit 3201 configured to receive an instruction for generating a reminding message;
a displaying unit 3202 configured to display an alternative message type of the reminding message; and
an implementing unit 3203 configured to generate a corresponding message based on a selected message type.

For example, the alternative message type includes at least one of the following items:
a standard type, a task type, an event type, an urging type, and a voting type.

The system, apparatus, modules or units illustrated in the above-described embodiments may be specifically implemented by a computer chip or entity, or by a product having a certain function. A typical implementing device is a computer. A specific form of the computer may be a personal computer, a laptop computer, a cellular phone, a camera phone, a smart phone, a personal digital assistant, a media player, a navigation device, an e-mail transmitter-receiver, a game console, a tablet computer, a wearable device, or a combination of any devices of these devices.

In a typical configuration, the computer includes one or more processors (CPU), an input/output interface, a network interface, and memory.

The memory may include forms, such as a volatile memory, a random-access memory (RAM), and/or a nonvolatile memory, e.g., a read only memory (ROM) or a flash RAM, in a computer readable medium. The memory is an example of the computer readable medium.

The computer readable medium includes permanent/non-permanent media and removable/non-removable media that can achieve information storage by any method or technology. The information may be a computer readable instruction, a data structure, a program module, or other data. Examples of the computer storage medium include, but are not limited to, a phase-change random access memory (PRAM), a static random access memory (SRAM), a dynamic random access memory (DRAM), a random access memory (RAM) of other type, a read only memory (ROM), an electrically erasable programmable read only memory (EEPROM), a flash RAM or other internal memory technology, a compact disc read only memory (CD-ROM), a digital versatile disc (DVD) or other optical storage, a magnetic cassette tape, and a magnetic tape or magnetic disk storage or other magnetic storage device, or any other non-transmission medium, which can be configured to store information that can be accessed by the computing device. As defined herein, the computer readable medium excludes transitory media, e.g., a modulated data signal or carrier wave.

It should be further noted that the terms such as “comprising,” “including,” or any other variations thereof are meant to cover the non-exclusive inclusions, such that the process, method, commodity, or apparatus that includes a series of elements not only includes those elements, but also includes other elements that are not explicitly listed, or further includes elements that already existed in such process, method, commodity, or apparatus. In a circumstance without more constraints, an element defined by the phrase “comprising a . . . ” does not preclude any other similar elements from existing in the process, method, commodity, or device that includes the element.

Here, the exemplary embodiments will be described in detail, and the examples thereof will be provided in the accompanying drawings. When the description below involves the accompanying drawings, like reference numerals refer to identical or similar elements in different accompanying drawings, unless otherwise indicated. The implementations described in the following exemplary embodiments do not represent all implementations consistent with the present disclosure. On the contrary, they are merely apparatus and method examples consistent with some example embodiments of the present disclosure, as described in the appended claims in detail.

As used in the present disclosure, the terms are intended merely to describe particular embodiments, and are not intended to limit the present disclosure. The singular forms of “a,” “the,” and “this” used in the present disclosure and the appended claims are also intended to include plural forms, unless the context clearly indicates other meanings. It should be further understood that, the term “and/or” used herein refers to any or all possible combinations including one or more associated listed items.

It shall be understood that various kinds of information may be described by using the terms, such as first, second, and third in the present disclosure, but the information should not be limited to these terms. These terms are merely used to distinguish between information of a given type. For example, the first piece of information may also be called the second piece of information, and similarly, the second piece of information may also be called the first piece of information, without departing from the scope of the present disclosure. Depending on the context, as used herein, the word “if” may be interpreted as “at the time of . . . ” or “when . . . ” or “in response to determining.”

The above description only provides example embodiments of the present disclosure and is not intended to limit the present disclosure. Any modification, equivalent replacement, improvement, and the like made within the spirit and principles of the present disclosure, should be included within the scope of protection of the present disclosure.

The present disclosure may further be understood with clauses as follows.

Clause 1. A method for event reminding, comprising:
a client terminal receiving an instruction for generating a reminding message for an event type;
the client terminal determining a to-be-reminded object and event description information corresponding to the event type; and the client terminal sending a reminding message to the to-be-reminded object, the reminding message containing the event description information.

Clause 2. The method according to clause 1, wherein the client terminal receiving an instruction for generating a reminding message for an event type comprises:
the client terminal receiving a user's creating operation for the reminding message and a user's selecting operation for type information of the reminding message; and
the client terminal determining that the instruction for generating a reminding message is received when the type information selected by the user's selecting operation is an event type.

Clause 3. The method according to clause 1, wherein the client terminal receiving an instruction for generating a reminding message for an event type comprises:
the client terminal receiving a user's triggering operation for a communication message, the user's triggering operation being used for instructing the client terminal to convert the communication message into a reminding message; and
the client terminal determining that the instruction for generating a reminding message is received when identifying that message content of the communication message contains event description information of a preset type.

Clause 4. The method according to clause 3, wherein the client terminal determining a to-be-reminded object and event description information corresponding to the event type comprises:
the client terminal extracting the event description information of a preset type contained in the message content, and the client terminal determining a communicator related to the communication message as the to-be-reminded object.

Clause 5. The method according to clause 1, wherein the event description information comprises at least one of the following items:
event theme information, event location information, event form information, and event time information.

Clause 6. The method according to clause 1, wherein the client terminal sending a reminding message to the to-be-reminded object comprises:
the client terminal sending the reminding message at a default or user-defined sending moment in accordance with a default or user-defined message type.

Clause 7. The method according to clause 1, wherein the method further comprises:
the client terminal receiving a response message returned by the to-be-reminded object, the response message containing acceptance status information of the to-be-reminded object for the event description information; and
the client terminal displaying the to-be-reminded object and the corresponding response message associatively.

Clause 8. The method according to clause 7, wherein when the acceptance status information is “reject,” the response message further comprises: a reason for rejection.

Clause 9. The method according to clause 1, wherein the method further comprises:

the client terminal adding a corresponding event in a management calendar of a communication application based on the event description information.

Clause 10. The method according to clause 1, wherein the method further comprises:
the client terminal receiving an adjustment request presented by the to-be-reminded object for at least one item of the event description information; and
the client terminal, when receiving a user's confirming operation for the adjustment request, sending an adjustment instruction for the reminding message to the to-be-reminded object based on adjusted event description information, or sending a new reminding message to the to-be-reminded object based on the adjusted event description information.

Clause 11. The method according to clause 1, wherein the method further comprises:
the client terminal, when failing to receive a response message returned by the to-be-reminded object within a preset time length after sending the reminding message, resending the reminding message to the to-be-reminded object, or displaying a repeated reminding option for the to-be-reminded object, to resend the reminding message to the to-be-reminded object when receiving a user's triggering operation for the repeated reminding option.

Clause 12. The method according to clause 1, wherein the reminding message contains a default or user-defined reminding time point and a default or user-defined reminding action, such that the to-be-reminded object is reminded of an event at the reminding time point based on the reminding action, and reminding content is related to the event description information.

Clause 13. The method according to clause 1, wherein the method further comprises:

the client terminal, based on an event start moment contained in the event description information, initiating a call request for the to-be-reminded object at the event start moment, to establish an audio connection or video connection.

Clause 14. The method according to clause 1, wherein the method further comprises:

the client terminal initiating a call booking request to a server terminal based on an event start moment contained in the event description information, the call booking request being used for instructing the server terminal to initiate a call to at least one of the client terminal and the to-be-reminded object at the event start moment, to establish an audio connection or video connection.

Clause 15. The method according to clause 1, wherein the client terminal sending a reminding message to the to-be-reminded object comprises:
the client terminal sending the reminding message to the server terminal, such that the server terminal sends the reminding message to the to-be-reminded object;
wherein the reminding message is used for instructing the server terminal to: initiate, based on the event start moment contained in the event description information, a call to at least one of the client terminals and the to-be-reminded object at the event start moment, to establish an audio connection or video connection.

Clause 16. The method according to any one of clauses 13-15, wherein the event description information contains event form information, the event form information indicating that the corresponding event is a teleconference or video conference.

Clause 17. A method for event reminding, comprising:
a client terminal receiving a reminding message of an event type; the client terminal displaying event description information contained in the reminding message; and
the client terminal returning a corresponding response message to a sender of the reminding message based on a received user's triggering operation for the event description information, the response message including acceptance status information for the event description information indicated by the user's triggering operation.

Clause 18. The method according to clause 17, wherein the client terminal returning a corresponding response message to a sender of the reminding message comprises:
the client terminal, when the acceptance status information indicated by the user's triggering operation is “agree,” directly returning the response message; and
the client terminal, when the acceptance status information indicated by the user's triggering operation is “reject,” further acquiring a corresponding reason for rejection, adding the reason for rejection to the response message, and returning the resulting response message to the sender.

Clause 19. The method according to clause 17, wherein the method further comprises:
the client terminal, when the acceptance status information indicated by the user's triggering operation is “agree,” adding a corresponding event in a management calendar of a communication application based on the event description information.

Clause 20. The method according to clause 17, wherein the method further comprises:
the client terminal, when the acceptance status information indicated by the user's triggering operation is “reject,” further acquiring adjustment information for at least one item of the event description information, and sending an adjustment request containing the adjustment information to the sender; and
the client terminal receiving a new reminding message returned by the sender, the new reminding message containing event description information adjusted based on the adjustment request; or the client terminal receiving an adjusting instruction returned by the sender based on the adjusted event description information, and adjusting the event description information in the reminding message based on the adjusting instruction.

Clause 21. The method according to clause 17, wherein the method further comprises:
the client terminal acquiring a reminding time point and a reminding action contained in the reminding message;
the client terminal initiating an event reminding request corresponding to the reminding time point and the reminding action to a server terminal; and
the client terminal responding to an event reminding event initiated by the server terminal at the reminding time point in the reminding action.

Clause 22. A method for generating an event reminding message, comprising:
a client terminal receiving an instruction for generating a reminding message; the client terminal displaying an alternative message type of the reminding message; and
the client terminal generating a corresponding message based on a selected message type.

Clause 23. The method according to clause 22, wherein the alternative message type comprises at least one of the following items:
a standard type, a task type, an event type, an urging type, and a voting type.

Clause 24. An apparatus for event reminding, comprising:
a receiving unit configured to receive an instruction for generating a reminding message for an event type;
a determining unit configured to determine a to-be-reminded object and event description information corresponding to the event type; and
a sending unit configured to send a reminding message to the to-be-reminded object, the reminding message containing the event description information.

Clause 25. The apparatus according to clause 24, wherein the receiving unit is specifically configured to:
make the client terminal receive a user's creating operation for the reminding message and a user's selecting operation for type information of the reminding message; and make the client terminal determine that the instruction for generating a reminding message is received when the type information selected by the user's selecting operation is an event type.

Clause 26. The apparatus according to clause 24, wherein the receiving unit is specifically configured to:
make the client terminal receive a user's triggering operation for a communication message, the user's triggering operation being used for instructing the client terminal to convert the communication message into a reminding message; and
make the client terminal determine that the instruction for generating a reminding message is received when identifying that message content of the communication message contains event description information of a preset type.

Clause 27. The apparatus according to clause 26, wherein the determining unit is specifically configured to:
make the client terminal extract the event description information of a preset type contained in the message content and make the client terminal determine a communicator related to the communication message as the to-be-reminded object.

Clause 28. The apparatus according to clause 24, wherein the event description information comprises at least one of the following items:
event theme information, event location information, event form information, and event time information.

Clause 29. The apparatus according to clause 24, wherein the sending unit is specifically configured to:
make the client terminal send the reminding message at a default or user-defined sending moment in accordance with a default or user-defined message type.

Clause 30. The apparatus according to clause 24, wherein the apparatus further comprises:
a response receiving unit configured to receive a response message returned by the to-be-reminded object, the response message containing acceptance status information of the to-be-reminded object for the event description information; and
a displaying unit configured to display the to-be-reminded object and the corresponding response message associatively.

Clause 31. The apparatus according to clause 30, wherein when the acceptance status information is “reject,” the response message further comprises: a reason for rejection.

Clause 32. The apparatus according to clause 24, wherein the apparatus further comprises:
an adding unit configured to add a corresponding event in a management calendar of a communication application based on the event description information.

Clause 33. The apparatus according to clause 24, wherein the apparatus further comprises:
a request receiving unit configured to receive an adjustment request presented by the to-be-reminded object for at least one item of the event description information; and
an adjusting unit configured to, when receiving a user's confirming operation for the adjustment request, send an adjustment instruction for the reminding message to the to-be-reminded object based on adjusted event description information, or send a new reminding message to the to-be-reminded object based on the adjusted event description information.

Clause 34. The apparatus according to clause 24, wherein the apparatus further comprises:
a repeatedly reminding unit configured to, when failing to receive a response message returned by the to-be-reminded object within a preset time length after sending the reminding message, resend the reminding message to the to-be-reminded object, or display a repeated reminding option for the to-be-reminded object, to resend the reminding message to the to-be-reminded object when receiving a user's triggering operation for the repeated reminding option.

Clause 35. The apparatus according to clause 24, wherein the reminding message contains a default or user-defined reminding time point and a default or user-defined reminding action, such that the to-be-reminded object is reminded of an event at the reminding time point based on the reminding action, and reminding content is related to the event description information.

Clause 36. The apparatus according to clause 24, wherein the apparatus further comprises:
a call requesting unit configured to initiate, based on an event start moment contained in the event description information, a call request for the to-be-reminded object at the event start moment, to establish an audio connection or video connection.

Clause 37. The apparatus according to clause 24, wherein the apparatus further comprises:
a call booking unit configured to initiate a call booking request to a server terminal based on an event start moment contained in the event description information, the call booking request being used for instructing the server terminal to initiate a call to at least one of the client terminal and the to-be-reminded object at the event start moment, to establish an audio connection or video connection.

Clause 38. The apparatus according to clause 24, wherein the sending unit is specifically configured to:
make the client terminal send the reminding message to a server terminal, such that the server terminal sends the reminding message to the to-be-reminded object;
wherein the reminding message is used for instructing the server terminal to: initiate, based on an event start moment contained in the event description information, a call to at least one of the client terminals and the to-be-reminded object at the event start moment, to establish an audio connection or video connection.

Clause 39. The apparatus according to clause 37 or 38, wherein the event description information contains event form information, the event form information indicating that the corresponding event is a teleconference or video conference.

Clause 40. An apparatus for event reminding, comprising:
a first receiving unit configured to receive a reminding message of an event type;
a displaying unit configured to display event description information contained in the reminding message; and
a returning unit configured to return a corresponding response message to a sender of the reminding message based on a received user's triggering operation for the event description information, the response message including acceptance status information for the event description information indicated by the user's triggering operation.

Clause 41. The apparatus according to clause 40, wherein the returning unit is specifically configured to:
make the client terminal, when the acceptance status information indicated by the user's triggering operation is “agree,” directly return the response message; and
make the client terminal, when the acceptance status information indicated by the user's triggering operation is “reject,” further acquire a corresponding reason for rejection, add the reason for rejection to the response message, and return the resulting response message to the sender.

Clause 42. The apparatus according to clause 40, wherein the apparatus further comprises:
an adding unit configured to, when the acceptance status information indicated by the user's triggering operation is “agree,” add a corresponding event in a management calendar of a communication application based on the event description information.

Clause 43. The apparatus according to clause 40, wherein the apparatus further comprises:
a sending unit configured to, when the acceptance status information indicated by the user's triggering operation is “reject,” further acquire adjustment information for at least one item of the event description information, and send an adjustment request containing the adjustment information to the sender; and
a second receiving unit configured to receive a new reminding message returned by the sender, the new reminding message containing event description information adjusted based on the adjustment request; or make the client terminal receive an adjusting instruction returned by the sender based on the adjusted event description information, and adjust the event description information in the reminding message based on the adjusting instruction.

Clause 44. The apparatus according to clause 40, wherein the apparatus further comprises:
an acquiring unit configured to acquire a reminding time point and a reminding action contained in the reminding message;
a requesting unit configured to initiate an event reminding request corresponding to the reminding time point and the reminding action to a server terminal; and
a responding unit configured to respond to an event reminding event initiated by the server terminal at the reminding time point in the reminding action.

Clause 45. An apparatus for generating an event reminding message, comprising:
a receiving unit configured to receive an instruction for generating a reminding message;
a displaying unit configured to display an alternative message type of the reminding message; and
an implementing unit configured to generate a corresponding message based on a selected message type.

Clause 46. The apparatus according to clause 45, wherein the alternative message type comprises at least one of the following items:
a standard type, a task type, an event type, an urging type, and a voting type.

Clause 47. A method for event reminding, comprising:
a client terminal generating a reminding message based on event description information and a to-be-reminded object; and
the client terminal sending the reminding message to the to-be-reminded object, the reminding message containing the event description information.

Clause 48. The method according to clause 47, wherein the client terminal generating a reminding message based on event description information and a to-be-reminded object comprises:
the client terminal receiving a user's creating operation for the reminding message and a user's selecting operation for type information of the reminding message; and when the type information selected by the user's selecting operation is an event type, the client terminal generating the reminding message based on the event type.

Clause 49. The method according to clause 47, wherein the client terminal generating a reminding message based on event description information and a to-be-reminded object comprises:
the client terminal receiving a user's triggering operation for a communication message, the user's triggering operation being used for instructing the client terminal to convert the communication message into a reminding message; and
the client terminal generating the reminding message when identifying that message content of the communication message contains event description information of a preset type.

Clause 50. An apparatus for event reminding, comprising:
a generating unit configured to generate a reminding message based on event description information and a to-be-reminded object; and
a sending unit configured to send the reminding message to the to-be-reminded object, the reminding message containing the event description information.

Clause 51. The apparatus according to clause 50, wherein the generating unit is specifically configured to:
make the client terminal receive a user's creating operation for the reminding message and a user's selecting operation for type information of the reminding message; and
when the type information selected by the user's selecting operation is an event type, make the client terminal generate the reminding message based on the event type.

Clause 52. The apparatus according to clause 50, wherein the generating unit is specifically configured to:
make the client terminal receive a user's triggering operation for a communication message, the user's triggering operation being used for instructing the client terminal to convert the communication message into a reminding message; and
make the client terminal generate the reminding message when identifying that message content of the communication message contains event description information of a preset type.

What is claimed is:

1. A method comprising:
receiving, by a client terminal, an instruction for generating a reminding message for an event type;
determining, by the client terminal a to-be-reminded object and event description information corresponding to the event type; and
sending, by the client terminal, a reminding message to the to-be-reminded object, the reminding message containing the event description information.

2. The method according to claim 1, wherein the receiving the instruction for generating the reminding message for the event type comprises:
receiving, by the client terminal, a user's creating operation for the reminding message and a user's selecting operation for type information of the reminding message; and
determining, by the client terminal, that the instruction for generating the reminding message is received, in response to determining that the type information selected by the user's selecting operation is the event type.

3. The method according to claim 1, wherein the receiving the instruction for generating the reminding message for the event type comprises:
receiving, by the client terminal, a user's triggering operation for a communication message, the user's triggering operation being used for instructing the client terminal to convert the communication message into a reminding message; and
determining, by the client terminal, that the instruction for generating a reminding message is received, in response to identifying that message content of the communication message contains event description information of a preset type.

4. The method according to claim 3, wherein the determining the to-be-reminded object and the event description information corresponding to the event type comprises:
extracting, by the client terminal, the event description information of a preset type contained in the message content; and
determining, by the client terminal, a communicator related to the communication message as the to-be-reminded object.

5. The method according to claim 1, wherein the event description information comprises at least one of the following:
event theme information;
event location information;
event form information; and
event time information.

6. The method according to claim 1, wherein the sending the reminding message to the to-be-reminded object comprises:
sending, by the client terminal, the reminding message at a default or user-defined sending moment in accordance with a default or user-defined message type.

7. The method according to claim 1, further comprising:
receiving, by the client terminal, a response message returned by the to-be-reminded object, the response message containing acceptance status information of the to-be-reminded object for the event description information; and
displaying, by the client terminal, the to-be-reminded object and the corresponding response message associatively.

8. The method according to claim 7, wherein when the acceptance status information is a rejection of an event corresponding to the event description information, the response message further comprises a reason for the rejection.

9. The method according to claim 1, further comprising:
adding, by the client terminal, a corresponding event in a management calendar of a communication application based on the event description information.

10. The method according to claim 1, further comprising:
receiving, by the client terminal, an adjustment request presented by the to-be-reminded object for at least one item of the event description information; and
sending, by the client terminal, an adjustment instruction for the reminding message to the to-be-reminded object based on adjusted event description information.

11. The method according to claim 1, further comprising:
receiving, by the client terminal, an adjustment request presented by the to-be-reminded object for at least one item of the event description information; and
sending, by the client terminal, a new reminding message to the to-be-reminded object based on the adjusted event description information.

12. The method according to claim 1, further comprising:
in response of failing to receive a response message returned by the to-be-reminded object within a preset time length after sending the reminding message, resending, by the client terminal, the reminding message to the to-be-reminded object.

13. The method according to claim 1, further comprising:
in response of failing to receive a response message returned by the to-be-reminded object within a preset time length after sending the reminding message, displaying a repeated reminding option for the to-be-reminded object, to resend the reminding message to the to-be-reminded object when receiving a user's triggering operation for the repeated reminding option.

14. The method according to claim 1, wherein the reminding message contains a default or user-defined reminding time point and a default or user-defined reminding action, such that the to-be-reminded object is reminded of an event at the reminding time point based on the reminding action, a reminding content being related to the event description information.

15. The method according to claim 1, further comprising:
based on an event start moment contained in the event description information, initiating, by the client terminal, a call request for the to-be-reminded object at the event start moment to establish an audio connection or video connection.

16. The method according to claim 1, further comprising:
initiating, by the client terminal, a call booking request to a server terminal based on an event start moment contained in the event description information, the call booking request being used for instructing the server terminal to initiate a call to at least one of the client terminal and the to-be-reminded object at the event start moment, to establish an audio connection or video connection.

17. The method according to claim 1, wherein the sending the reminding message to the to-be-reminded object comprises:
sending, by the client terminal, the reminding message to the server terminal, such that the server terminal sends the reminding message to the to-be-reminded object,
wherein the reminding message is used for instructing the server terminal to initiate, based on an event start moment contained in the event description information, a call to at least one of the client terminals and the to-be-reminded object at the event start moment, to establish an audio connection or video connection.

18. The method according to claims 17, wherein the event description information contains event form information, the event form information indicating that the corresponding event is a teleconference or video conference.

19. An electronic device comprising:
one or more processors; and
one or more computer readable media storing computer-readable instructions that, executable by the one or more processors, cause the one or more processors to perform acts comprising:
receiving a reminding message of an event type;
displaying event description information contained in the reminding message; and
returning a corresponding response message to a sender of the reminding message based on a received user's triggering operation for the event description information, the response message including acceptance status information for the event description information indicated by the user's triggering operation.

20. One or more computer readable media storing computer-readable instructions that, executable by one or more processors, cause the one or more processors to perform acts comprising:
receiving an instruction for generating a reminding message;
displaying an alternative message type of the reminding message; and
generating a corresponding message based on a selected message type.
